(19) United States
(12) Patent Application Publication
(10) Pub. No.: US 2026/0169207 A1
(43) Pub. Date: Jun. 18, 2026

(54) MULTILAYERED ARTICLES INCLUDING A UV BARRIER LAYER

(71) Applicant: 3M INNOVATIVE PROPERTIES COMPANY, St. Paul, MN (US)

(72) Inventors: Timothy J. Hebrink, Scandia, MN (US); James A. Phipps, River Falls, WI (US); Daniel L. Solberg, Chippewa Falls, WI (US); Alexander C. Eldredge, Mahtomedi, MN (US); Panagiotis Maroulis, Blainville (CA); Jodi L. Connell, St. Paul, MN (US); Chris A. Praggastis, Renton, WA (US); Marcus M. Borgstrom, Hudson, WI (US)

(21) Appl. No.: 19/127,504

(22) PCT Filed: Nov. 16, 2023
(86) PCT No.: PCT/IB2023/061616

§ 371 Date: May 6, 2025

Related U.S. Application Data
(60) Provisional application No. 63/435,669, filed on Dec. 28, 2022.

(51) Int. Cl. G02B 5/20

(52) U.S. Cl. CPC G02B 5/208

(57) ABSTRACT

The present disclosure provides a multilayered article including a substrate layer including a fluoropolymer or a silicone polymer; a 15-60 nanometer-thick metal oxide layer directly attached to the substrate layer; and an adhesive layer adjacent to the metal oxide layer opposite the substrate layer. The article exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

### SUMMARY

In a first aspect, a multilayered article is provided. The multilayered article comprises a substrate layer comprising a fluoropolymer or a silicone polymer; a metal oxide layer directly attached to a major surface of the substrate layer, the metal oxide layer having a thickness of 15 nanometers (nm) to 60 nm; and an adhesive layer adjacent to a major surface of the metal oxide layer opposite the substrate layer. The article exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

UVC irradiation has been employed to disinfect surfaces contaminated with bacteria and viruses. However, exposure to UVC radiation can cause certain materials to start to degrade. It was unexpectedly discovered that a thin layer of a metal oxide could both provide UV barrier properties and enhance adhesion of an adhesive to a fluoropolymer or a silicone polymer substrate layer.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1A is a schematic cross-sectional view of an exemplary article;

FIG. 1B is a schematic cross-sectional view of an exemplary article;

FIG. 1C is a perspective review of a Cartesian coordinate system of a surface that can be utilized to describe various microstructured surfaces;

FIG. 2A is a cross-sectional view of a microstructured surface;

FIG. 2B is a perspective view of a microstructured surface;

FIG. 3 is a perspective view of a microstructured surface comprising a linear array of prisms;

FIG. 4A is a perspective view of a microstructured surface comprising an array of cube corner elements;

FIG. 4B is a perspective view of a microstructured surface comprising an array of pyramid elements;

FIG. 4C is a perspective view illustrating the dimensions and angles of a cube corner element;

FIG. 5 is a perspective view of a microstructured surface comprising an array of preferred geometry cube corner elements;

FIG. 6 is a cross-sectional view of peak structures with various apex angles;

FIGS. 7A-7B are three-dimensional topographical maps of microstructured surfaces comprising an array of peak structures;

FIGS. 8A-8C are three-dimensional topographical maps of microstructured surfaces comprising an array of peak structures;

FIG. 9 is a plot of the complement of the cumulative gradient (i.e. slope) magnitude distribution (Fcc);

FIG. 10 is a plot of the complement of the cumulative X slope (Ycc);

FIG. 11 is a plot of the complement of the cumulative Y slope (Xcc);

FIG. 12 is a schematic side view of a structure; and

FIG. 13 is a schematic depiction of a process for making a substrate having a microstructured surface.

While the above-identified figures set forth various embodiments of the disclosure, other embodiments are also contemplated, as noted in the description. In all cases, this disclosure presents the invention by way of representation and not limitation. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

### Glossary

As used herein, “fluoropolymer” refers to any organic polymer containing fluorine.

As used herein, “nonfluorinated” means not containing fluorine.

As used herein, “(co)polymer” or “(co)polymers” includes homo(co)polymers and (co)polymers, as well as homo(co)polymers or (co)polymers that may be formed in a miscible blend, (e.g., by coextrusion or by reaction, including, (e.g., transesterification)). The term “(co)polymer” includes random, block and star (co)polymers.

As used herein, “adjacent” encompasses both in direct contact (e.g., directly adjacent) and having one or more intermediate layers present between the adjacent materials.

As used herein, “incident” with respect to light refers to the light falling on or striking a material.

As used herein, “crosslinked” (co)polymer refers to a (co)polymer whose (co)polymer chains are joined together by covalent chemical bonds, usually via crosslinking molecules or groups, to form a network (co)polymer. A crosslinked (co)polymer is generally characterized by insolubility but may be swellable in the presence of an appropriate solvent.

As used herein, “cure” refers to a process that causes a chemical change, e.g., crosslinking or other reaction that creates a covalent bond to solidify a multilayer film layer or increase its viscosity.

As used herein, “cured (co)polymer” includes both crosslinked and uncrosslinked (co)polymers.

As used herein, “metal” includes a pure metal or a metal alloy.

As used herein, “film” or “layer” refers to a single stratum within a multilayer article.

As used herein, “substrate” encompasses films and layers, including microstructured films/layers.

As used herein, the term “essentially free” in the context of a composition being essentially free of a component, refers to a composition containing less than 1% by weight (wt. %), 0.5 wt. % or less, 0.25 wt. % or less, 0.1 wt. % or less, 0.05 wt. % or less, 0.001 wt. % or less, or 0.0001 wt. % or less of the component, based on the total weight of the composition.

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

As used herein, the term “glass transition temperature” (Tg), of a polymer refers to the transition of a polymer from a glassy state to a rubbery state and can be measured using Differential Scanning Calorimetry (DSC), such as at a heating rate of 10° C. per minute in a nitrogen stream. When the Tg of a monomer is mentioned, it is the Tg of a homopolymer of that monomer. The homopolymer must be sufficiently high molecular weight such that the Tg reaches a limiting value, as it is generally appreciated that a Tg of a homopolymer will increase with increasing molecular weight to a limiting value. The homopolymer is also understood to be substantially free of moisture, residual monomer, solvents, and other contaminants that may affect the Tg. A suitable DSC method and mode of analysis is as described in Matsumoto, A. et. al., J. Polym. Sci. A., Polym. Chem. 1993, 31, 2531-2539.

As used herein, “(meth)acryl” or “(meth)acrylate” with respect to a monomer, oligomer, (co)polymer or compound means a vinyl-functional alkyl ester formed as the reaction product of an alcohol with an acrylic or a methacrylic acid.

As used herein, “optically clear” refers to an article in which there is no visibly noticeable distortion, haze or flaws as detected by the naked eye at a distance of about 1 meter, preferably about 0.5 meters.

As used herein, “optical thickness” when used with respect to a layer refers to the physical thickness of the layer times its in-plane index of refraction.

As used herein, “vapor coating” or “vapor depositing” means applying a coating to a substrate surface from a vapor phase, for example, by evaporating and subsequently depositing onto the substrate surface a precursor material to the coating or the coating material itself. Exemplary vapor coating processes include, for example, physical vapor deposition (PVD), chemical vapor deposition (CVD), and combinations thereof.

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture, or in interpreting the claims.

As used herein, “radiation” refers to electromagnetic radiation unless otherwise specified.

As used herein, “scattering” with respect to wavelengths of light refers to causing the light to depart from a straight path and travel in different directions with different intensities.

As used herein, “reflectance” is the measure of the proportion of light or other radiation striking a surface at normal incidence which is reflected off it. Reflectivity typically varies with wavelength and is reported as the percent of incident light that is reflected from a surface (0 percent—no reflected light, 100—all light reflected). Reflectivity and reflectance are used interchangeably herein.

As used herein, “reflective” and “reflectivity” refer to the property of reflecting light or radiation, especially reflectance as measured independently of the thickness of a material.

As used herein, “average reflectance” refers to reflectance averaged over a specified wavelength range.

As used herein, “absorption” refers to a material converting the energy of light radiation to internal energy.

As used herein, “absorb” with respect to wavelengths of light encompasses both absorption and scattering, as scattered light also eventually gets absorbed. Absorbance can be measured with methods described in ASTM E903-12 “Standard Test Method for Solar Absorptance, Reflectance, and Transmittance of Materials Using Integrating Spheres”. Absorbance measurements described herein were made by making transmission measurements as previously described and then calculating absorbance using Equation 1.

As used herein, the term “absorbance” with respect to a quantitative measurement refers to the base 10 logarithm of a ratio of incident radiant power to transmitted radiant power through a material. The ratio may be described as the radiant flux received by the material divided by the radiant flux transmitted by the material. Absorbance (A) may be calculated based on internal transmittance (T) according to Equation 1:

$$A = - {log}_{10} T \qquad ( 1 )$$

Emissivity can be measured using infrared imaging radiometers with methods described in ASTM E1933-14 (2018) “Standard Practice for Measuring and Compensating for Emissivity Using Infrared Imaging Radiometers.” According to Kirchhoffs law of thermal radiation, absorbance correlates with emittance. Absorbance, absorptivity, emissivity, and emittance are used interchangeably herein for the same purpose of emitting infrared energy to the atmosphere. Absorb and emit are also used interchangeably herein.

As used herein, the terms “transmittance” and “transmission” refer to the ratio of total transmission of a layer of a material compared to that received by the material, which may account for the effects of absorption, scattering, reflection, etc. Transmittance (T) may range from 0 to 1 or be expressed as a percentage (T %).

As used herein, “transparent” refers to a material (e.g., film or layer) that absorbs less than 20% of light having wavelengths between 350 nm and 2500 nm.

As used herein, “bandwidth” refers to a width of a contiguous band of wavelengths.

As used herein, “utilitarian” means that the discontinuities provide a positive contribution to the functioning of the article. For instance, easy-clean utilitarian discontinuities provide a positive contribution to the function of cleaning an article easier than an article lacking the utilitarian discontinuities. Representative examples of utilitarian discontinuities include, but are not limited to, cube-corner elements and parallel linear prisms with planar facets.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, a multilayered article is provided. The multilayered article comprises:
a substrate layer comprising a fluoropolymer or a silicone polymer;
a metal oxide layer directly attached to a major surface of the substrate layer, the metal oxide layer having a thickness of 15 nanometers (nm) to 60 nm; and
an adhesive layer adjacent to a major surface of the metal oxide layer opposite the substrate layer,
wherein the article exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

In some cases, the article exhibits an average transmission of at least one of 0°, 30°, 45°, 60°, or 75° incident light angle of light over a wavelength bandwidth of at least 30 nanometers having a wavelength between 200 nm to 280 nm, 200 nm to 300 nm, or 200 nm to 320 nm, of 10% or less, 7%, 5%, or 2% or less.

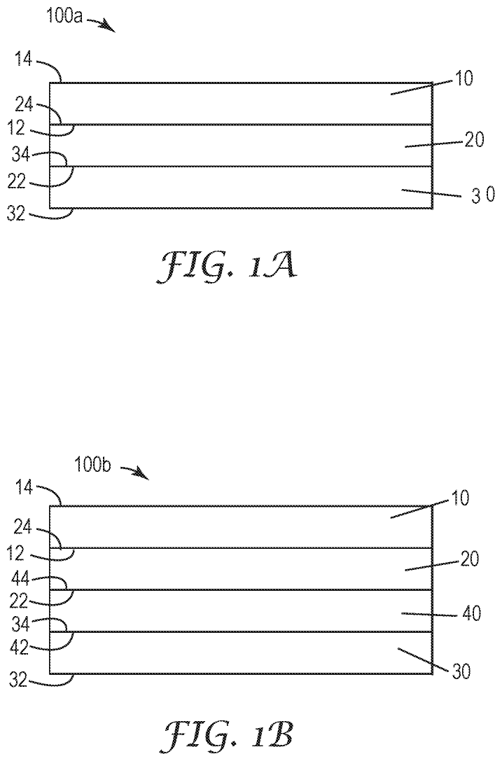

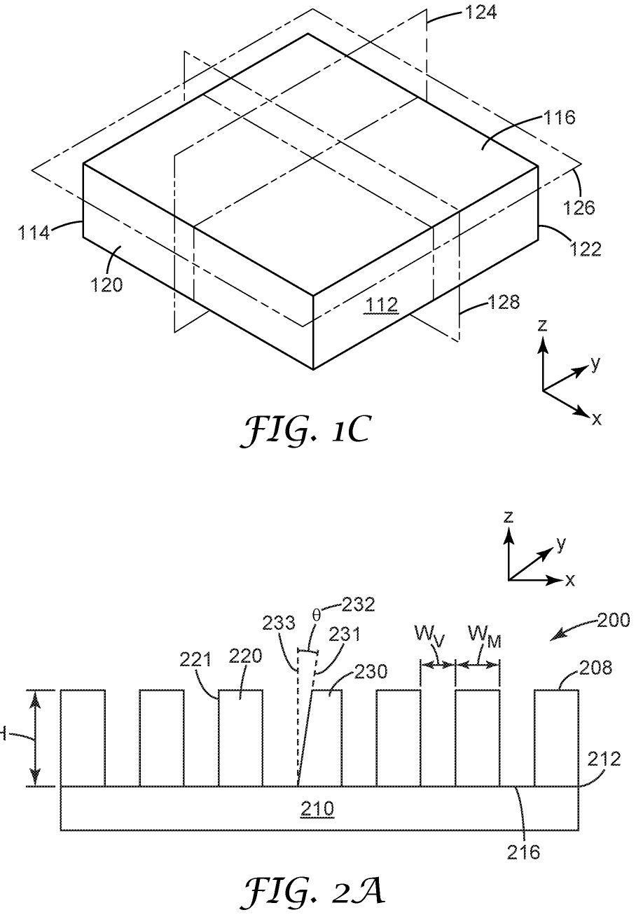

Referring to FIG. 1A, a multilayered article 100a comprises a substrate layer 10 comprising a fluoropolymer or a silicone polymer; a metal oxide layer 20 directly attached to a major surface 12 of the substrate layer, the metal oxide layer 20 having a thickness of 15 nanometers (nm) to 60 nm; and an adhesive layer 30 adjacent to a major surface 22 of the metal oxide layer 20 opposite the substrate layer 10. In this embodiment, the adhesive layer 30 is directly adjacent to (i.e., attached to) a major surface 22 of the metal oxide layer 20.

It is additionally noted that the substrate layer 10 has a major surface 14 opposite the major surface 12, the metal oxide layer 20 has a major surface 24 opposite the major surface 22, and the adhesive layer has opposing major surfaces 32 and 34. In certain embodiments, the major surface 12 of the substrate layer 10 is directly adjacent to the major surface 24 of the metal oxide layer 20 and the major surface 22 of the metal oxide layer 20 is directly adjacent to the major surface 34 of the adhesive layer 30.

Referring to FIG. 1B, a multilayered article 100b comprises a substrate layer 10 comprising a fluoropolymer or a silicone polymer; a metal oxide layer 20 directly attached to a major surface 12 of the substrate layer, the metal oxide layer 20 having a thickness of 15 nanometers (nm) to 60 nm; an adhesive layer 30 adjacent to a major surface 22 of the metal oxide layer 20 opposite the substrate layer 10; and an intermediate layer 40 disposed between the metal oxide layer 20 and the adhesive layer 30. One or more intermediate layers may be represented by the depiction of the layer 40 in FIG. 1B.

It is additionally noted that the intermediate layer(s) 40 has opposing major surfaces 42 and 44. In certain embodiments, the major surface 42 of the intermediate layer 40 is directly adjacent to the major surface 34 of the adhesive layer 30 and the major surface 44 of the intermediate layer 40 is directly adjacent to the major surface 22 of the metal oxide layer 20.

One suitable intermediate layer is a primer layer, e.g., to improve adhesion between the metal oxide layer and the adhesive layer. In some cases, a primer layer may be formed by a pretreatment regimen involving electrical discharge pretreatment of the metal oxide layer in the presence of a reactive or non-reactive atmosphere (e.g., plasma, glow discharge, corona discharge, dielectric barrier discharge or atmospheric pressure discharge), chemical pretreatment, or flame pretreatment. In one embodiment, the method can include plasma pretreatment. In some cases, a primer layer may be formed from a material such as a primer commercially available under the trade designations “BETAPRIME” or “TYVEK”, both from DuPont (Wilmington, DE)

As mentioned above, it has been discovered that a thin layer of a metal oxide could both provide UV barrier properties and enhance adhesion of an adhesive to a fluoropolymer or a silicone polymer substrate layer. Preferably, the adhesion is such that the article exhibits a peel force between the metal oxide layer and the adhesive layer of 500 grams per inch (196.9 grams per centimeter) or greater. Preferably, the adhesion is such that the article exhibits a peel force between the substrate layer and the metal oxide layer of 500 grams per inch (196.9 grams per centimeter) or greater. One way of determining that the article has UV barrier properties is to measure a change in light transmission through the article following exposure of the article to UVC light. For example, the inclusion of the metal oxide layer in the article preferably results in the article exhibiting a change in light transmission at a wavelength of 400 nm of less than 10% following exposure to UVC light having a wavelength of 254 nm at a dosage of 50 megajoules per square meter (MJ/m²).

### Metal Oxide Layer

Typically, the metal oxide layer comprises titanium oxide, aluminum oxide, zinc oxide, tantalum pentoxide, zirconium oxide, or niobium oxide. In select embodiments, the metal oxide layer comprises titanium oxide.

It is noted that various multilayer optical films have employed at least one metal oxide layer to collectively provide at least one tailored optical property, including for instance specific transmission of wavelengths over a desired range. However, the metal oxide layer of the present disclosure is not a part of a multilayer optical film. Stated another way, the metal oxide layer does not make up one layer of a multilayer optical film. Rather, the metal oxide layer is composed of a continuous 15-60 nm thickness of one or more metal oxides. Accordingly, the metal oxide layer could be formed of just one metal oxide or could be formed of a combination of two or more metal oxides.

A thickness of the metal oxide layer is 15 nm or greater, 17 nm, 20 nm, 22 nm, 25 nm, 27 nm, or 30 nm or greater; and 60 nm or less, 57 nm, 55 nm, 52 nm, 50 nm, 47 nm, 45 nm, 42 nm, 40 nm, 37 nm, 35 nm, 32 nm, 30 nm, 27 nm, 25 nm, 22 nm, or 20 nm or less. In some cases, a thickness of the metal oxide layer is 15 nm to 20 nm, 20 nm to 30 nm, or 20 nm to 40 nm. When the thickness is less than 15 nm it can be difficult to form a continuous layer instead of discontinuous islands of deposited metal oxide material. When the thickness is too great, the metal oxide layer risks imparting a visible color to the article and/or decreasing transmission of visible light through the metal oxide layer.

Preferably, the metal oxide layer does not contribute to the article having a yellow appearance. Whether or not an article has a yellow-colored appearance can be determined, for instance, by measuring the transmission of light through the article. A lack of a yellow-colored appearance is found in an article that exhibits an average transmission of at least one of 0°, 30°, 45°, 60°, or 75° incident light angle of light having a wavelength range of at least above 410 nm of 70% or greater. Concomitantly, an article that exhibits an average transmission of at least one of 0°, 30°, 45°, 60°, or 75° incident light angle of light having a wavelength range of at least above 410 nm of less than 70% is likely to appear yellow.

As noted above, the article (e.g., overall) exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

The metal oxide layer can typically be prepared by evaporation, reactive evaporation, sputtering, reactive sputtering, chemical vapor deposition, plasma enhanced chemical vapor deposition, and atomic layer deposition. Preferred methods include vacuum preparations such as sputtering and evaporation. For instance, in some cases one of two forms of physical vapor deposition (PVD) are used: evaporation or sputtering. Evaporated coatings rely upon heating the coating material (evaporant) to a temperature at which it evaporates. This is followed by condensation of the vapor upon a substrate. For evaporated coatings, the electron-beam deposition process is most commonly used. Sputtered coatings use energetic gas ions to bombard a material (“target”) surface, ejecting atoms which then condense on the nearby substrate. Depending upon which coating method is used, and the settings used for that method, thin film coating rate and structure-property relationships will be strongly influenced. Ideally, coating rates should be high enough to allow acceptable process throughput and film performance, characterized as dense, low stress, void free, non-optically absorbing coated layers.

### Adhesive Layer

Exemplary suitable adhesives for the adhesive layer include pressure-sensitive adhesives and hot melt adhesives. In select embodiments, the adhesive layer comprises a pressure-sensitive adhesive.

Classes of suitable pressure sensitive adhesives include acrylics, tackified rubber, tackified synthetic rubber, ethylene vinyl acetate and the like. Suitable acrylic adhesives are disclosed, for example, in U.S. Pat. No. 3,239,478 (Harlan); U.S. Pat. No. 3,935,338 (Robertson); U.S. Pat. No. 5,169,727 (Boardman); U.S. Pat. No. 4,952,650 (Young et al.) and U.S. Pat. No. 4,181,752 (Martens et al.), incorporated herein by reference.

In some cases, the adhesive is transparent. In select embodiments, the adhesive is optically clear, which means that the adhesive has both transparency and clarity (e.g., low haze). In certain embodiments, an optically clear adhesive (OCA) is selected from an acrylate, a polyurethane, a polyolefin (such as a polyisobutylene (PIB)), a silicone, or a combination thereof. Illustrative OCAs include those described in International Pub. No. WO 2008/128073 (Everaerts et al.) relating to antistatic optically clear pressure sensitive adhesives, U.S. Pat. App. Pub. Nos. US 2009/089137 (Sherman et al.) relating to stretch releasing OCA, US 2009/0087629 (Everaerts et al.) relating to indium tin oxide compatible OCA, US 2010/0028564 (Cheng et al.) relating to antistatic optical constructions having optically transmissive adhesive, US 2010/0040842 (Everaerts et al.) relating to adhesives compatible with corrosion sensitive layers, US 2011/0126968 (Dolezal et al.) relating to optically clear stretch release adhesive tape, and U.S. Pat. No. 8,557,378 (Yamanaka et al.) relating to stretch release adhesive tapes. Suitable OCAs include acrylic optically clear pressure sensitive adhesives such as, for example, 3M OCA 8146, 8211, 8212, 8213, 8214, and 8215, each available from 3M Company, St. Paul, MN. Some suitable silicone adhesives are commercially available under the trade designations “3M Adhesive Transfer Tape 91022” (e.g., 2 mil thick clear roll) and “3M Adhesive Transfer Tape 96042”, both from 3M Company (St. Paul, MN).

In some embodiments, the adhesive may be resistant to ultraviolet radiation damage. Exemplary adhesives which are typically resistant to ultraviolet radiation damage include silicone adhesives and acrylic adhesives containing UV-stabilizing/blocking additive(s), for example. U.S. Pat. No. 5,504,134 (Palmer et al.), for instance, describes attenuation of polymer substrate degradation due to ultraviolet radiation through the use of metal oxide particles in a size range of about 0.001 to about 0.2 microns (in some embodiments, about 0.01 microns to about 0.15 microns) in diameter. U.S. Pat. No. 5,876,688 (Laundon), describes a method for producing micronized zinc oxide that are small enough to be transparent when incorporated as UV blocking and/or scattering agents in paints, coatings, finishes, plastic articles, cosmetics and the like which are well suited for use in the present disclosure. These fine particles such as zinc oxide and titanium oxide with particle sizes ranging from 10 nm to 100 nm that can attenuate UV radiation are available, for example, from Kobo Products, Inc., South Plainfield, NJ.

A suitable hot melt adhesive includes the fluoropolymer THV (e.g., THV221 available as 3M DYNEON THV221 from 3M Company) as an alternative to the adhesives described above. In particular, THV221 is resistant to UV degradation and can be hot melt extruded onto the article.

In select embodiments, the adhesive layer comprises a polyisobutylene adhesive, a silicone adhesive, or a (meth)acrylic adhesive.

### Substrate Layer

As noted above, the substrate layer comprises a fluoropolymer or a silicone polymer. In certain embodiments, the substrate layer comprises a fluoropolymer.

Many fluoropolymers are advantageously resistant to UV radiation. Examples of fluoropolymers that may be used include copolymers of tetrafluoroethylene (TFE), hexafluoropropylene (HFP), and vinylidene fluoride (e.g., available from 3M Company under the trade designation 3M DYNEON THV); a copolymer of TFE, HFP, vinylidene fluoride, and perfluoropropyl vinyl ether (PPVE) (e.g., available from 3M Company under the trade designation 3M DYNEON THVP); a polyvinylidene fluoride (PVDF) (e.g., 3M DYNEON PVDF 6008 from 3M Company); ethylene chlorotrifluoroethylene polymer (ECTFE) (e.g., available as HALAR 350LC ECTFE from Solvay, Brussels, Belgium); an ethylene tetrafluoroethylene copolymer (ETFE) (e.g., available as 3M DYNEON ETFE 6235 from 3M Company); perfluoroalkoxyalkane polymers (PFA); fluorinated ethylene propylene copolymer (FEP); a polytetrafluoroethylene (PTFE); copolymers of TFE, HFP, and ethylene (HTE) (e.g., available as 3M DYNEON HTE1705 from 3M Company). Combinations of fluoropolymers can also be used. In some embodiments, the fluoropolymer includes FEP. In some embodiments, the fluoropolymer includes PFA.

In certain embodiments, the substrate layer comprises a fluoropolymer (co)polymer comprising polymerized units derived from one or more monomers selected from tetrafluoroethylene, hexafluoropropylene, vinylidene fluoride, a perfluoroalkoxy alkylene, or a combination thereof. Suitable fluoropolymers are available under the trade name “TEFLON FEP100” from E. I. DuPont de Nemours, Wilmington, DE, or which “TEFLON FEP100 500A is currently preferred. Suitable exemplary fluoropolymers also include copolymers of tetrafluorethylene, hexafluoropropylene, and vinylidene fluoride (THV) under the trade designations “DYNEON THV 220,” “DYNEON THV 221,” “DYNEON THV 230,” “DYNEON THV 2030,” “DYNEON THV 415”, “DYNEON THV 500”, “DYNEON THV 610”, and “DYNEON THV 815” from Dyneon LLC, Oakdale, MN.

In certain embodiments, the substrate layer comprises a silicone thermoplastic polymer. One suitable silicone is available under the trade name “DOW CORNING 93-500 SPACE GRADE ENCAPSULANT KIT” from Dow Corning Corporation, Midland, MI. Another suitable silicone is available under the trade name “SILPURAN FILM” from Wacker Chemie AG, Munich, Germany.

In some cases, the substrate layer has a thickness of 10 microns or greater, 15, 20, 25, 30, 35, 40, 50, 60, 70, 80, 90, 100, 120, 140, 160, 180, 200, 220, or 250 microns or greater; and 500 microns or less, 475, 450, 425, 400, 375, 350, 325, 300, 275, 250, 225, 200, 175, 150, 125, or 100 microns or less. In select embodiments, the substrate layer is a single layer having a thickness described above. In certain embodiments, the substrate layer is self-supporting.

Certain microstructured surfaces exhibit better bacteria removal when cleaned, even in comparison to smooth surfaces. In some cases, the substrate layer is a microstructured substrate comprising: a base layer having a thickness of at least 1 micron; and a plurality of microstructures extending across a first surface of the base layer.

Although articles with specific microstructure features are useful for reducing the initial formation of a biofilm, particularly for medical articles; in the case of other articles, such microstructured surfaces can be difficult to clean. This is surmised to be due at least in part to the bristles of a brush or fibers of a (e.g., nonwoven) wipe being larger than the space between microstructures. It has been found that some types of microstructured surfaces exhibit better microorganism (e.g., bacteria) removal when cleaned, even in comparison to smooth surfaces. The article is typically not a sterile implantable medical article. Rather, the microstructured surface typically comes in contact with people and/or animals as well as other contaminants (e.g., dirt). Some representative articles include for example surfaces or component of a medical article, a dental article, an orthodontic article (e.g., an orthodontic aligner), a vehicular article, an electronic article, a personal care article, a cleaning article, an athletic article, a food preparation article, a child care article, or an architectural article.

The microstructured surface typically provides a log 10 reduction of microorganism (e.g., bacteria) of at least 2, 3, 4, 5, 6, 7, or 8 after cleaning. Regardless of whether the microstructured surface is mechanically cleaned with a wipe or brush and/or cleaned by applying an antimicrobial solution to the microstructured surface, the microstructured surface provides improved removal of microorganism (e.g., bacteria) in comparison to surfaces lacking the microstructures.

With reference to FIG. 1, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector.

In some embodiments, the microstructured surfaces are three-dimensional on a macroscale. However, on a microscale (e.g., surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

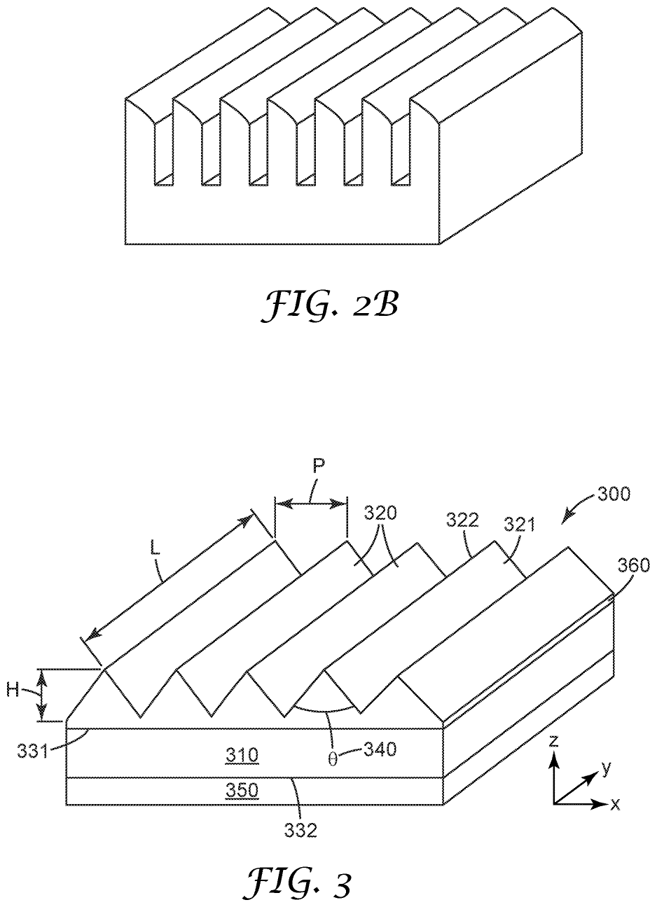

FIG. 2A is an illustrative cross-section of a microstructured surface 200 of utilitarian discontinuities. Such cross-section is representative of a plurality of discrete (e.g., post or rib) microstructures 220. The microstructures comprise a base 212 adjacent to an (e.g., engineered) planar surface 216 (surface 116 of FIG. 1C that is parallel to reference plane 126). Top (e.g., planar) surfaces 208 (parallel to surface 216 and reference plane 126 of FIG. 1C) are spaced from the base 212 by the height (“H”) of the microstructure. The side wall 221 of microstructure 220 is perpendicular to planar surface 216. When the side wall 221 is perpendicular to planar surface 216, the microstructure has a side wall angle of zero degrees. In the case of perpendicular side walls, of a peak microstructure are parallel to each other and parallel to adjacent microstructures having perpendicular side walls. Alternatively, microstructure 230 has side wall 231 that is angled rather than perpendicular relative to planar surface 216. The side wall angle 232 can be defined by the intersection of the side wall 231 and a reference plane 233 perpendicular to planar surface 216 (perpendicular to reference plane 126 and parallel to reference plane 128 of FIG. 1C). In the case of privacy films, for instance, such as described in U.S. Pat. No. 9,335,449 (Gaides et al.); the wall angle is typically less than 10, 9, 8, 7, 6, or 5 degrees. Since the channels of privacy film comprise light absorbing material, larger wall angle can decrease transmission. However, wall angles approaching zero degrees are also more difficult to clean.

Suitable surfaces are microstructured surfaces comprising microstructures having side wall angles greater than 1, 2, 3, 4, 5, 6, 7, 8, 9, or 10 degrees. In some embodiments, the side wall angle is at least 11, 12, 13, 14, 15, 16, 17, 18, 19, or 20 degrees. In other embodiments, the side wall angle is at least 21, 22, 23, 24, 25, 26, 27, 28, 29, or 30 degrees. For example, in some embodiments, the microstructures are cube corner peak structures having a side wall angle of 30 degrees. In other embodiments, the side wall angle is at least 31, 32, 33, 34, 35, 36, 37, 38, 39, 40, 41, 42, 43, 44, or 45 degrees. For example, in some embodiments, the microstructures are prism structures having a side wall angle of 45 degrees. In other embodiments, the side wall angle is at least 46, 47, 48, 49, 50, 51, 52, 53, 54, 55, 56, 57, 58, 59, or 60 degrees. It is appreciated that the microstructured surface would be beneficial even when some of the side walls have lower side wall angles. For example, if half of the array of peak structures have side wall angles within the desired range, about half the benefit of improved microorganism (e.g., bacteria) removal may be obtained. Thus, in some embodiments, less than 50, 45, 40, 35, 30, 25, 20, 15, 10, 5 or 1% of the peak structures have side wall angles less than 10, 9, 8, 7, 6, 5, 4, 3, 2, or 1 degree. In some embodiments, less than 50, 45, 40, 35, 30, 25, 20, 15, 10, 5 or 1% of the peak structures have side wall angles less than 30, 25, 20, or 15 degrees. In some embodiments, less than 50, 45, 40, 35, 30, 25, 20, 15, 10, 5 or 1% of the peak structures have side wall angles less than 40, 35, or 30 degrees, at least 50, 60, 70, 80, 90, 95 or 99% of the peak structures have a sufficiently large side wall angle, as described above.

As described for example in PCT Publication No. WO 2013/003373 (Bommarito et al.), microstructures having a cross-sectional dimension no greater than 5 microns are believed to substantially interfere with the settlement and adhesion of target bacteria most responsible for healthcare-associated infections or other biofouling problems such an increased drag, reduced heat transfer, filtration fouling, etc. With reference to FIG. 2A, the cross-sectional width of the microstructure (“W_{M}”) as depicted in this figure, is less than or equal to the cross-sectional width of the channel or valley (“W_{V}”) between adjacent microstructures. Thus, as depicted (in this linear prism embodiment), when the cross-section width of the microstructure (W_{M}) is no greater than 5 microns, the cross-sectional width of the channel or valley (W_{V}) between microstructures is also no greater than 5 microns. When the microstructures on either side of a valley have a side wall angel of zero, such as depicted by microstructure 220 of FIG. 2A, the channel or valley defined by the side walls has the same width (W_{V}) adjacent the top surface 208 as adjacent the bottom surface 212. When the microstructure has a side wall angle of greater than zero, such as depicted by the line 231 of microstructure 230, the valley typically has a greater (e.g., maximum) width adjacent the top surface 208 as compared to the width of the channel or valley adjacent the bottom surface 212. It has been found that when the side wall angle is too small, and/or the maximum width of the valley is too small, and/or the microstructured surface comprises an excess amount of flat surface area, the microstructured surface is more difficult to clean.

Suitable microstructured surfaces comprise microstructures wherein the maximum width of the valleys is at least 1, 2, 3, or 4 microns and optionally greater than 5, 6, 7, 8, 9, or 10 microns, ranging up to 250 microns. In some embodiments, the maximum width of the valleys is at least 1, 2, 3, 4, 5, 6, 7, 8, 9, 10, 11, 12, 13, 14, 15, 16, 17, 18, 19, 20, 21, 22, 23, 24, or 25 microns. In some embodiments, the maximum width of the valleys is no greater than 1000, 950, 900, 850, 800, 750, 700, 650, 600, 550, 500, 450, 400, 350, 300, 250, 225, 200, 175, 150, 125, 100, 75, or 50 microns. In some embodiments, the maximum width of the valleys is no greater than 45, 40, 35, 30, 25, 20, or 15 microns. It is appreciated that the microstructured surface would be beneficial even when some of the valleys are less than the maximum width. For example, if half of the total number of valleys of the microstructured surface are within the desired range, about half the benefit may be obtained. Thus, in some embodiments, less than 50, 45, 40, 35, 30, 25, 20, 15, 10, 5 or 1% of the valleys have a maximum width of less than 10, 9, 8, 7, 6, or 5 microns. Alternatively, at least 50, 60, 70, 80, 90, 95 or 99% of the valleys have a maximum width, as described above.

In typical embodiments, the maximum width of the microstructures falls within the same ranges as described for the valleys. In other embodiments, the width of the valleys can be greater than the width of the microstructures. Thus, in some favored embodiments, the microstructured surface is typically substantially free of microstructures having a width less than 5, 4, 3, 2, or 1 micron, inclusive of nanostructures having a width less than 1 micron. By substantially free, it is meant that there are none of such microstructures present or that some may be present provided that the presence thereof does not detract from the cleanability properties as will subsequently described.

The microstructured surface may or may not comprise nanostructures.

Although smaller structures including nanostructures can prevent biofilm formation, the presence of a significant number of smaller valleys and/or valleys with insufficient side wall angles can impede cleanability including dirt removal. Hence, typically the microstructured surface lacks a significant number of structures with smaller valleys and/or valleys with insufficient side wall angles that can impede cleanability including dirt removal. Further, microstructured surfaces with larger microstructures and valleys can typically be manufactured at a faster rate. Thus, in typical embodiments, each of the dimensions of the microstructures is at least 1, 2, 3, 4, 5, 6, 7, 8, 9, 10, 11, 12, 13, 14, or 15 microns. Further, in certain embodiments, none of the dimensions of at least 50, 60, 70, 80, 90, 95 or 99% microstructures are less than 5, 4, 3, 2, or 1 micron.

In some embodiments, the microstructured surface is typically substantially free of microstructures having a width less than 5, 4, 3, 2, or 1 micron, inclusive of nanostructures having a width less than 1 micron. Some examples of microstructured surfaces that further comprise nanostructures are described in previously cited WO 2012/058605. Nanostructures typically comprise at least one or two dimensions that do not exceed 1 micron (e.g., width and height) and typically one or two dimensions that are less than 1 micron. In some embodiments, all the dimensions of the nanostructures do not exceed 1 micron or are less than 1 micron.

By substantially free, it is meant that there are none of such microstructures present or that some may be present provided that the presence thereof does not detract from the (e.g., cleanability) properties as will subsequently described. Thus, the microstructured surface or microstructures thereof may further comprise nanostructures provided that the microstructured surface provides a reduction in the presence of microorganisms after cleaning and/or reduction in microorganism touch transfer, as described herein. Further, in this embodiment, the presence of smaller microstructures and/or nanostructures does not prevent or significantly reduce the formation of biofilm.

In some embodiments, the microstructured surface may further comprise nanostructures. Other microstructured surfaces further comprising nanostructures are known. For example, Zhang et al., US 2013/0216784, describes superhydrophobic films that comprise flat faces spaced apart by valleys. The valleys and faces may be covered by nanostructures. The superhydrophobic film has a static water contact angle of at least 140, 145, or 145 degrees. Such nanostructures typically have an aspect ratio of at least 1:1, 2:1, 3:1, 4:1, 5:1 or 6:1. The ratio of nanostructures to microstructures, as illustrated in the drawings, is about 20:1.

In other embodiments, wherein the microstructured surface comprises little or no nanostructures, the ratio of nanostructures to microstructures is less than 20:1, 15:1, 10:1, 5:1, 4:1, 3:1, 2:1 or 1:1.

In other embodiments, the microstructured surface may further comprise randomly distributed recesses, as described in Aronson et al., WO 2009/079275. The presence of the randomly distributed recesses improves the diffusion, as compared to the same microstructured surface lacking such recesses.

The presence of nanostructures and recesses can trap dirt, especially clay having a particle size less than 1 micron. However, the microstructured surface may comprise nanostructures and randomly distributed recesses for embodiments wherein the microstructured surface is utilized inside a display or other uses wherein the microstructured surface is not cleaned.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is substantially parallel to the planar base layer. In one embodiment, the valleys may have flat surfaces and only one of the side walls of the peaks is angled such as shown in FIG. 2B. However, in favored embodiments, both side walls of adjacent peaks defining the valley(s) are angled toward each other, as previously depicted. Thus, the side walls on either side of a valley are not parallel to each other.

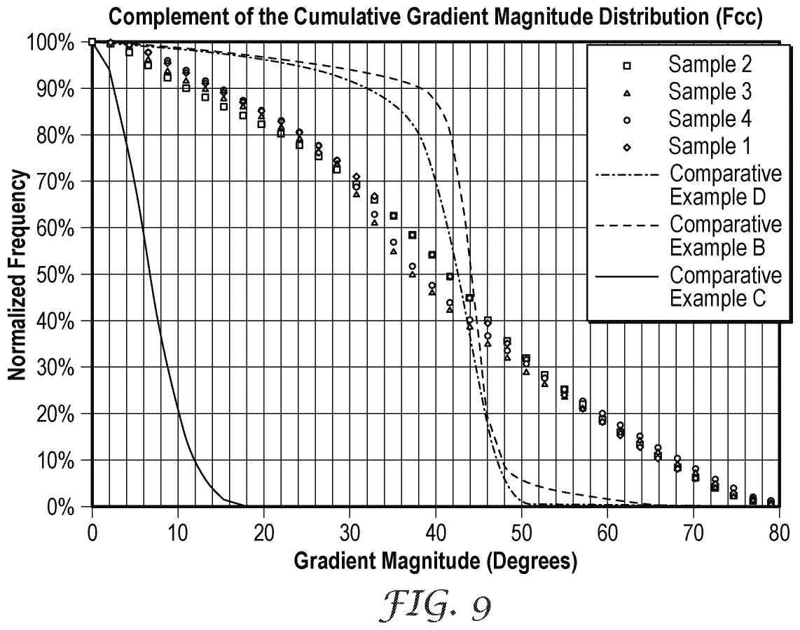

FIG. 9 of WO 2021/033151 depicts a comparative microstructured surface having discontinuous valleys. Such surface has also been described as having groupings of features arranged with respect to one another as to define a tortuous pathway. Rather, the valleys are intersected by walls forming an array of individual cells, each cell surrounded by walls. Some of the cells are about 3 microns in length; whereas other cells are about 11 microns in length.

The valleys of suitable microstructured surfaces are substantially free of intersecting side walls or other obstructions to the valley. By substantially free, it is meant that there are no side walls or other obstructions present within the valleys or that some may be present provided that the presence thereof does not detract from the cleanability properties. The valleys are typically continuous in at least one direction. This can facilitate the flow of a cleaning solution through the valley. Thus, the arrangement of peaks typically does not define a tortuous pathway.

The peak structures typically have a height (H) ranging from 1 to 250 microns. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 225, 200, 175, 150, 125, 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, 10, 9, 8, 7, 6, or 5 microns. In select embodiments, the peak structures each have a height of 10 to 250 microns. In typical embodiments, the height of the valley or channel is within the same range as just described for the peak structures. In some embodiments, the peak structures and valleys have the same height.

The aspect ratio of the valley is the height of the valley (which can be the same as the peak height of the microstructure) divided by the maximum width of the valley. In some embodiments, the aspect ratio of the valley is at least 0.1, 0.15, 0.2, or 0.25. In some embodiments, the aspect ratio of the valley is no greater than 1, 0.9, 0.8, 0.7, 0.6 or 0.5. Thus, in some embodiments, the height of the valley is typically no greater than the maximum width of the valley, and more typically less than the maximum width of the valley.

The base of each microstructure may comprise various cross-sectional shapes including but not limited to paralellograms with optionally rounded corners, rectangles, squares, circles, half-circles, half-ellipses, triangles trapezoids, other polygons (e.g., pentagons, hexagons, octagons, etc., and combinations thereof).

Suitable microstructured surfaces comprise an array of peak structures and adjacent valleys. The valleys preferably have a maximum width ranging from 1 micron to 250 microns. In some embodiments (e.g., for improved cleanability), the peak structures have a side wall angle greater than 10 degrees. The peak structures may comprise two or more facets such as in the case of a linear array of prisms or an array of cube-corners elements. In some embodiments, facets of the peak structures form an apex angle, typically ranging from about 20 to 120 degrees. The facets form continuous or semi-continuous surfaces in the same direction. The valleys typically lack intersecting walls.

The presently described microstructured surface does not prevent microorganisms (e.g., bacteria such as Streptococcus mutans, Staphylococcus aureus, or Pseudomonas aeruginosa) from being present on the microstructured surface, or in other words, does not prevent biofilm from forming. However, such microstructured surfaces have been demonstrated to be easier to clean, providing a low amount of microorganism (e.g., bacteria) present after cleaning. Without intending to be bound by theory, scanning electron microscopy images suggest that large continuous biofilms typically form on a smooth surface. However, even though the peaks and valleys are much larger than the microorganism (e.g., bacteria), the biofilm is interrupted by the microstructured surface. In some embodiments, the biofilm (before cleaning) is present as discontinuous aggregate and small groups of cells on the microstructured surface, rather than a continuous biofilm. After cleaning, biofilm aggregates in small patches cover the smooth surface. However, the microstructured surface was observed to have only small groups of cells and individual cells after cleaning. In favored embodiments, the microstructured surface provides a log 10 reduction of microorganism (e.g., bacteria such as Streptococcus mutans, Staphylococcus aureus, or Pseudomonas aeruginosa) of at least 2, 3, 4, 5, 6, 7 or 8 after cleaning. In some embodiments, the microstructured surface has a mean log 10 of recovered colony forming units of microorganism of less than 6, 5, 4, or 3 after cleaning for a highly contaminated surface.

In some embodiments, the microstructured surface can prevent an aqueous or (e.g., isopropanol) alcohol-based cleaning solution from beading up as compared to a smooth surface comprised of the same polymeric material. When a cleaning solution beads up or in other words dewets, the disinfectant agent may not be in contact with a microorganism for a sufficient duration of time to kill the microorganism. However, it has been found that at least 50, 60, 70, 80, or 90% of the microstructured surface can comprise cleaning solution 1, 2, and 3 minutes after applying the cleaning solution to the microstructured surface.

In one embodiment, the microstructured surface may have the same surface as a brightness enhancing film. As described for example in U.S. Pat. No. 7,074,463 (Jones et al.), backlit liquid crystal displays generally include a brightness enhancing film positioned between a diffuser and a liquid crystal display panel. The brightness enhancing film collimates light, thereby increasing the brightness of the liquid crystal display panel and also allowing the power of the light source to be reduced. Thus, brightness enhancing films have been utilized as an internal component of an illuminated display devices (e.g., cell phone, computer) that are not exposed to microorganisms (e.g., bacteria) or dirt.

With reference to FIG. 3, in one embodiment, the microstructured surface 300 comprises a linear array of regular right prisms 320. Each prism has a first facet 321 and a second facet 322. The prisms are illustrated as formed on a base member 310 that has a first planar surface 331 (parallel to reference plane 126) on which the prisms are formed and a second surface 332 that is substantially flat or planar and opposite first surface. By right prisms it is meant that the apex angle θ, 340, is typically about 90°. However, this angle can range from 70° to 120° and may range from 80° to 100°. These apexes can be sharp (as shown), rounded, or truncated. The spacing between (e.g., prism) peaks may be characterized as pitch (“P”). In this embodiment, the pitch is also equal to the maximum width of the valley. Thus, the pitch is greater than 1, 2, 3, 4, 5, 6, 7, 8, 9, or 10 microns ranging up to 250 microns, as previously described. The length (“L”) of the (e.g., prism) microstructures is typically the largest dimension and can span the entire dimension of the microstructured surface. The prism facets need not be identical and the prisms may be tilted with respect to each other, as shown in FIG. 6.

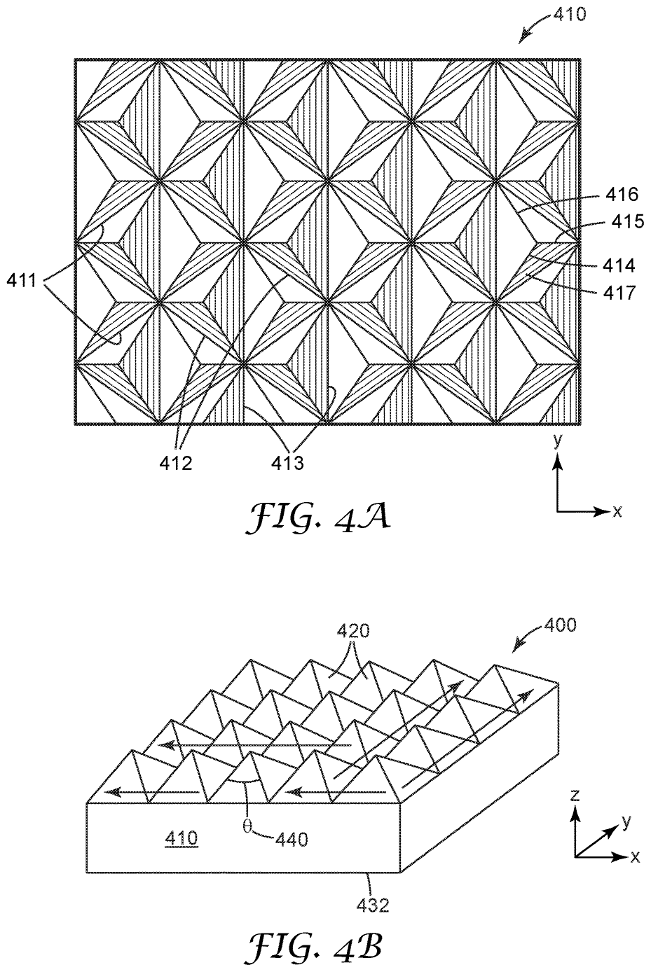

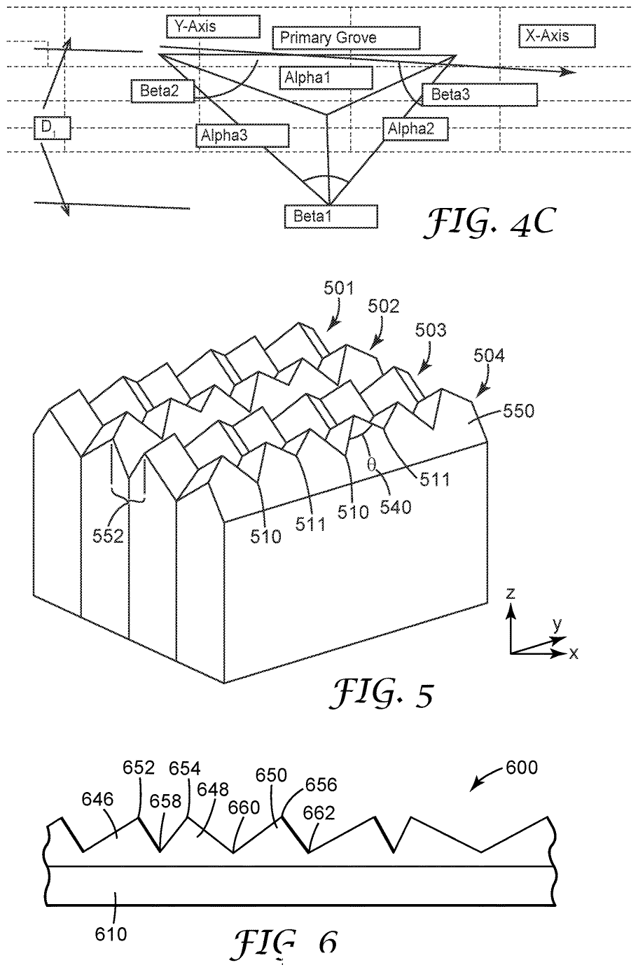

In another embodiment, the microstructured surface may have the same surface as cube corner retroreflective sheeting. Retroreflective materials are characterized by the ability to redirect light incident on the material back toward the originating light source. This property has led to the widespread use of retroreflective sheeting for a variety of traffic and personal safety uses. With reference to FIG. 4A, cube corner retroreflective sheeting typically comprises a thin transparent layer having a substantially planar front surface and a rear structured surface 410 comprising a plurality of cube corner elements 417. A seal film (not shown) is typically applied to the backside of the cube-corner elements; see, for example, U.S. Pat. No. 4,025,159 (McGrath) and U.S. Pat. No. 5,117,304 (Huang et al.). The seal film maintains an air interface at the backside of the cubes that enables total internal reflection at the interface and inhibits the entry of contaminants such as soil and/or moisture.

The microstructured surface 410 of FIG. 4A may be characterized as an array of cube corner elements 417 defined by three sets of parallel grooves (i.e., valleys) 411, 412, and 413; two sets of grooves (i.e., valleys) intersect each other at an angle greater than 60 degrees and a third set of grooves (valleys) intersects each of the other two sets at an angle less than 60 degrees to form an array of canted cube corner element matched pairs (see U.S. Pat. No. 4,588,258 (Hoopman)). The angles for the grooves are chosen such that the dihedral angle formed at the linear of intersection of the grooves, e.g., 414, 415, and 416 for representative cube-corner element 417 are about 90 degrees. In some embodiments, the triangular base has angle of at least 64, 65, 66, 67, 68, 69, or 70 degrees and the other angles are 55, 56, 57, or 58 degrees.

In another embodiment, depicted in FIG. 4B, the microstructured surface 400 of FIG. 4B may be characterized as an array of pyramidal peak structures 420 defined by a first set of parallel grooves (i.e., valleys) in the y direction and a second set of parallel groves in the x direction. The base of the pyramidal peak structures is a polygon, typically a square or rectangle depending on the spacing of the grooves. The apex angle θ, 440, is typically about 90°. However, this angle can range from 70° to 120° and may range from 80° to 100°. In other embodiments, the apex angle is at least 20°, 30°, 40°, 50°, or 60°.

Other cube corner element structures, described as “full cubes” or “preferred geometry (PG) cube corner elements”, typically comprise at least two non-dihedral edges that are not coplanar as described for example in U.S. Pat. No. 7,188,960 (Smith); incorporated herein by reference. Full cubes are not truncated. In one aspect, the base of full cube elements in plan view are not triangular. In another aspect, the non-dihedral edges of full cube elements are characteristically not all in the same plane (i.e., not coplanar). Such cube corner elements may be characterized as “preferred geometry (PG) cube corner elements”. A PG cube corner element may be defined in the context of a structured surface of cube corner elements that extends along a reference plane. A PG cube corner element means a cube corner element that has at least one non-dihedral edge that: (1) is nonparallel to the reference plane; and (2) is substantially parallel to an adjacent non-dihedral edge of a neighboring cube corner element. A cube corner element with reflective faces that comprise rectangles (inclusive of squares), trapezoids or pentagons are examples of PG cube corner elements.

With reference to FIG. 5, in another embodiment the microstructured surface 500 may comprise an array of preferred geometry (PG) cube corner elements. The illustrative microstructured surface comprises four rows (501, 502, 503, and 504) of preferred geometry (PG) cube corner elements. Each row of preferred geometry (PG) cube corner elements has faces formed from a first and second groove set also referred to as “side grooves”. Such side grooves range from being nominally parallel to non-parallel to within 1 degree to adjacent side grooves. Such side grooves are typically perpendicular to reference plane 124 of FIG. 1C. The third face of such cube corner elements preferably comprises a primary groove face 550. This primary groove face ranges from being nominally perpendicular to non-perpendicular within 1 degree to the face formed from the side grooves. In some embodiments, the side grooves can form an apex angle θ, of nominally 90 degrees. In other embodiments, the row of preferred geometry (PG) cube corner elements comprises peak structures formed from an alternating pair of side grooves 510 and 511 (e.g., about 75 and about 105 degrees) as depicted in FIG. 5. Thus, the apex angle 540 of adjacent (PG) cube corner elements can be greater than or less than 90 degrees. In some embodiments, the average apex angle of adjacent (PG) cube corner elements in the same row is typically 90 degrees. As described in previously cited U.S. Pat. No. 7,188,960, during the manufacture of a microstructured surface comprising PG cube corner elements, the side grooves can be independently formed on individual lamina (thin plates), each lamina having a single row of such cube corner elements. Pairs of laminae having opposing orientation are positioned such that their respective primary groove faces form primary groove 552, thereby minimizing the formation of vertical walls. The lamina can be assembled to form a microstructured surface which is then replicated to form a tool of suitable size.

In some embodiments, all the peak structures have the same apex angle θ. For example, the previously described microstructured surface of FIG. 3 depicts a plurality of prism structures, each having an apex angle θ of 90 degrees. As another example, the previously described microstructured surface of FIG. 4B depicts a plurality of pyramidal structures, each having an apex angle θ of 60 degrees. In other embodiments, the peak structures may form apex angles that are not the same. For example, as depicted in FIG. 5, some of the peak structures may have an apex angle greater than 90 degrees and some of the peak structures may have an apex angle less than 90 degrees. In some embodiments, the peak structures of an array of microstructures have peak structures with different apex angles, yet the apex angles average a value ranging from 60 to 120 degrees. In some embodiments, the average apex angle is at least 65, 70, 75, 80, or 85 degrees. In some embodiments, the average apex angle is less than 115, 110, 100, or 95 degrees.

As yet another example, as depicted in the cross-section of FIG. 6, the microstructured surface 600 may comprise a plurality of peak structures such as 646, 648, and 650 having peaks 652, 654, and 656, respectively. When the microstructured surface is free of flat surfaces, (i.e., surfaces that are parallel to reference plane 126 of FIG. 1C), the facets of adjacent peak structures may also define the valley between adjacent peaks. In some embodiments, the facets of the peak structure form a valley with a valley angle of less than 90 degrees (e.g., valley 658). In some embodiments, the facets of the peak structure form a valley with a valley angle of greater than 90 degrees (e.g., valley 660). In some embodiments, the valleys are symmetrical, such as depicted by valleys 658 and 660. In other embodiments, the valleys are symmetrical such as depicted by valley 662. When the valley is symmetrical the side walls of adjacent peak structures that define the valley are substantially the same. When the valley is asymmetrical, the side walls of adjacent peak structures that define the valley are different. The microstructured surface may have a combination of symmetrical and asymmetrical valleys.

In some embodiments, the peak structures typically comprise at least two (e.g., prisms of FIG. 3), three (e.g., cube corners of FIG. 4A) or more facets. For example, when the base of the microstructure is an octagon the peak structures comprise eight side wall facets. However, when the facets have rounded or truncated surfaces, the microstructures may not be characterized by a specific geometric shape.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is substantially parallel to the planar base layer. In one embodiment, the valleys may have flat surfaces and only one of the side walls of the peaks is angled such as shown in FIG. 2B. However, in favored embodiments, both side walls of adjacent peaks defining the valley(s) are angled toward each other, as previously depicted. Thus, the side walls on either side of a valley are not parallel to each other.

In each of the embodiments of FIGS. 3-6, the facets of adjacent (e.g., prism or cube corner) peak structures are typically connected at the bottom of the valley, i.e., proximate the planar base layer. The facets of the peak structures form a continuous surface in the same direction. For example, in FIG. 3, the facets 321 and 322 of the (e.g., prism) peak structures are continuous in the direction of the length (L) of the microstructures or in other words, the y-direction. As yet another example, the primary grooves 452 and 550 of the PG cube corner elements of FIG. 5 form a continuous surface in the y-direction. In other embodiments, the facets form a semi-continuous surface in the same direction. For example, in FIG. 4, facets of the (e.g., cube corner or pyramidal) peak structures are in the same plane in both the x- and y-directions. These semi-continuous and continuous surfaces can assist in the cleaning of pathogens from the surface.

In some embodiments, the apex angle of the peak structure is typically two times the wall angle, particularly when the facets of the peak structures are interconnected at the valleys between peak structures. Thus, the apex angle is typically greater than 20 degrees and more typically at least 25, 30, 35, 40, 45, 50, 55, or 60 degrees. The apex angle of the peak structure is typically less than 160 degrees and more typically less than 155, 150, 145, 140, 135, 130, 125 or 120 degrees.

The microstructured surface of the microstructured film can be prepared by various microreplication techniques such as coating, injection molding, embossing, laser etching, and extrusion. For example, microstructuring of the (e.g., engineered) film surface can be achieved by at least one of (1) casting a molten thermoplastic using a tool having a microstructured pattern, (2) coating of a fluid onto a tool having a microstructured pattern, solidifying the fluid, and removing the resulting film, (3) passing a thermoplastic film through a nip roll to compress against a tool having a microstructured pattern (i.e., embossing), and/or (4) contacting a solution or dispersion of a polymer in a volatile solvent to a tool having a microstructured pattern and removing the solvent, e.g., by evaporation. The tool can be metallic, such as nickel, nickel-plated copper or brass, or can be a thermoplastic material that is stable under the process conditions, and that preferably has a surface energy that allows clean removal of the polymerized material from the tool. It is to be understood that the microstructured film should comprise a material that will not melt or otherwise deform during the thermoforming process of forming the article such that the utilitarian discontinuities of the microstructured surface of the film maintain their shapes and impart the inverse of their shapes to a surface of the final article.

A tool used for preparing the microstructured film can be formed using any of a number of techniques known to those skilled in the art, selected depending in part upon the tool material and features of the desired topography. Illustrative techniques include etching (e.g., chemical etching, mechanical etching, or other ablative means such as laser ablation or reactive ion etching, etc., and combinations thereof), photolithography, stereolithography, micromachining, knurling (e.g., cutting knurling or acid enhanced knurling), scoring, cutting, etc., or combinations thereof. In some embodiments, the tool is a metal tool. The tool may further comprise a diamond like glass layer, such as described in WO 2009/032815 (David).

Additional information regarding materials and various processes for forming the microstructured tool surface can be found, for example, in PCT Publication No. WO 2007/070310 and US Publication No. US 2007/0134784 (Halverson et al.); US Publication No. US 2003/0235677 (Hanschen et al.); PCT Publication No. WO 2004/000569 (Graham et al.); U.S. Pat. No. 6,386,699 (Ylitalo et al.); US Publication No. US 2002/0128578 (Johnston et al.) and U.S. Pat. Nos. 6,420,622, 6,867,342, and 7,223,364 (Johnston et al.); and U.S. Pat. No. 7,309,519 (Scholz et al.).

Useful (optional) base member materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, silicone and fluorinated films, and glass. Optionally, the base material can contain mixtures or combinations of these materials. In an embodiment, the base may be multi-layered or may contain a dispersed component suspended or dispersed in a continuous phase. An example of a useful PET films include photograde polyethylene terephthalate and MELINEX™ PET available from DuPont Films of Wilmington, Del. An example of a useful thermoformable material is polyethylene terephthalate (polyester with glycol) commercially available as VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418).

It also is possible and often preferable in order to maintain the fidelity of the microstructures to include a surface energy modifying compound in the composition used to form the microstructures. In some embodiments, the bloom additive may retard or prevent crystallization of the base composition. Suitable bloom additives may be found, for example, in International Publication No. WO 2009/152345 (Scholz et al.) and U.S. Pat. No. 7,879,746 (Klun et al.).

The materials for retroreflective sheeting and brightness enhancing films have been chosen based on the optical properties. Thus, the peak structures and adjacent valleys typically comprise a material having a refractive index of at least 1.50, 1.55, 1.60 or greater. Further, the transmission of visible light is typically greater than 85 or 90%. However, optical properties may not be of concern for many embodiments of the presently described films, methods, and articles. Thus, various other materials may be used having a lower refractive index including colored, light transmissive, and opaque.

As shown in FIG. 3, a continuous land layer 360 can be present between the bottom of the channels or valleys and the top surface 331 of (e.g., planar) base member 310. In some embodiments, such as when the microstructured surface is prepared from casting and curing a polymerizable resin composition, the thickness of the land layer is typically at least 0.1, 0.2, 0.3, 0.4, 0.5, 0.6, 0.7 0.8, 1, 2, 3, 4, or 5 microns ranging up to 50 microns. In some embodiments, the thickness of the land layer is no greater than 45, 40, 35, 30, 25, 20, 15, 10, 9, 8, 7, 6, 5, 4, 3, 2, 1, 0.9, 0.8, 0.7, 0.6, 0.5, 0.4, 0.3, or 0.2 microns.

In some embodiments, the microstructured surface (e.g., at least peak structures thereof) comprise an organic polymeric material with a glass transition temperature (as measured with Differential Scanning Calorimetry) of at least 25° C. In some embodiments, the organic polymeric material has a glass transition temperature of at least 30, 35, 40, 45, 50, 55 or 60° C. In some embodiments, the organic polymeric material has a glass transition temperature no greater than 100, 95, 90, 85, 80, or 75° C.

Referring again to FIGS. 2-4 and 6, the presently microstructured (e.g., tooling) film optionally comprises an (e.g., engineered) microstructured surface (200, 300, 400, 600) disposed on a base member (210, 310, 410, 610). In some cases, the base member is planar (e.g., parallel to reference plane 126). The thickness of the base member is typically at least 10, 15, 20, or 25 microns (1 mil) and typically no greater than 500 microns (20 mil) thickness. In some embodiments, the thickness of the base member is no greater than 400, 300, 200, or 100 microns. The width of the (e.g., film) base member may be is at least 30 inches (122 cm) and preferably at least 48 inches (76 cm). The base member may be continuous in its length for up to about 50 yards (45.5 m) to 100 yards (91 m) such that the microstructured film is provided in a conveniently handled roll-good. Alternatively, however, the (e.g., film) base member may be individual sheets or strips rather than as a roll-good.

In certain embodiments, the microstructured surface comprises peak structures and adjacent valleys, wherein the valleys have a maximum width ranging from 1 micron to 250 microns and the peak structures have a side wall angle of greater than 10 degrees.

In some embodiments, the microstructured surfaces are three-dimensional on a macroscale. However, on a microscale (e.g., surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

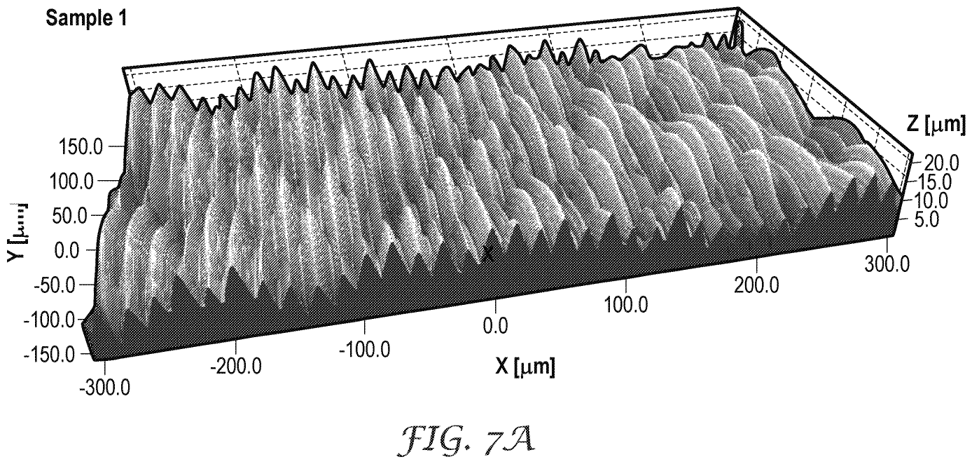

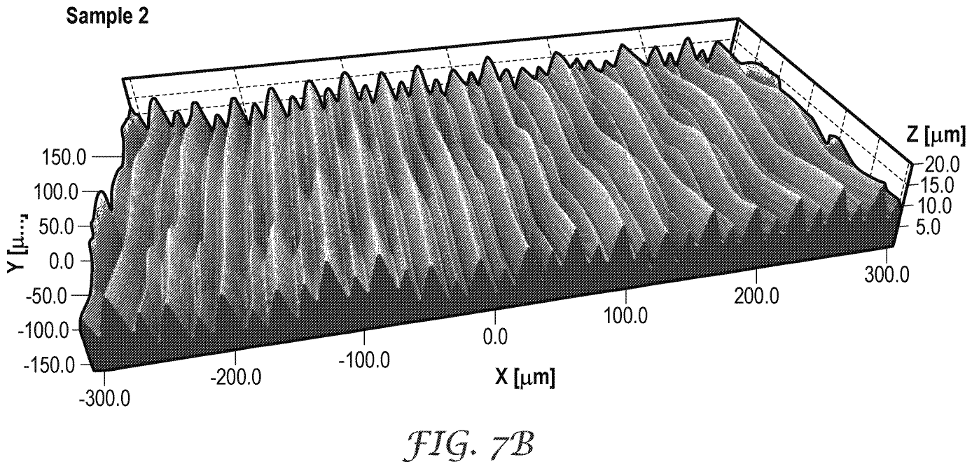

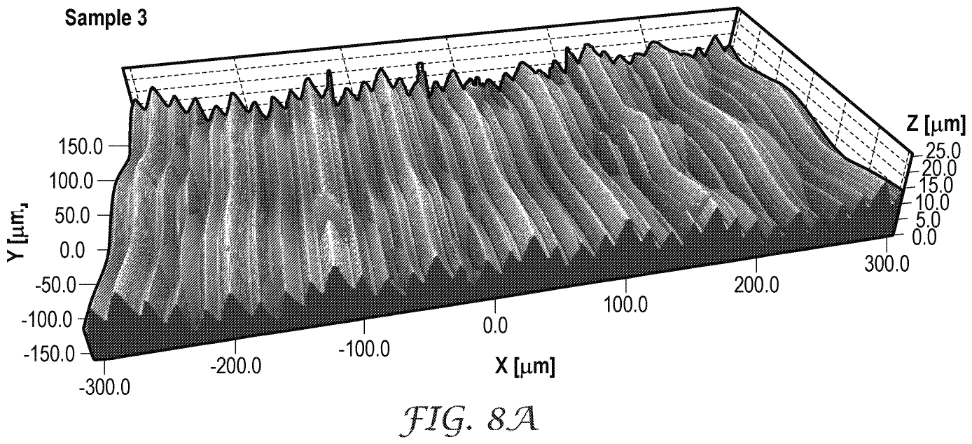

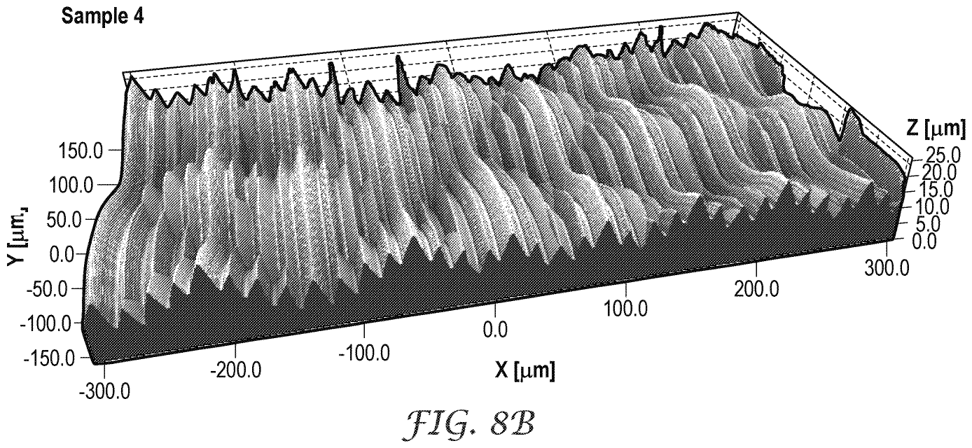

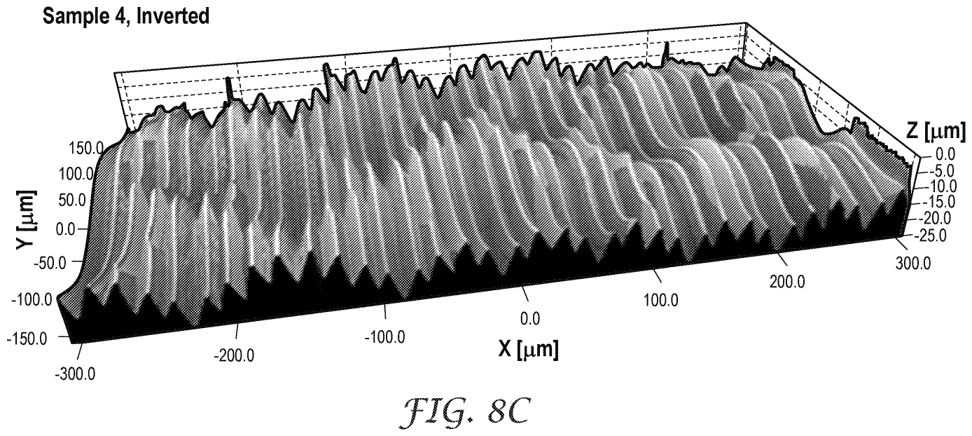

Presently described are more complex microstructured surfaces, such as illustrated by FIGS. 7A-7B and 8A-8C. The microstructured surfaces can be made using any suitable fabrication technique. For example, the microstructures can be fabricated using microreplication from a tool. The tool may be fabricated using any suitable fabrication method, such as by using engraving or diamond turning. Exemplary methods are known in the art, such as described in U.S. Pat. No. 8,888,333; WO2000/048037; U.S. Pat. Nos. 7,140,812; 7,350,442 and 7,328,638 (Gardiner); incorporated herein by reference.

Formation of such microstructured surfaces is described in detail in WO 2023/105372 (Jones et al.), incorporated herein by reference in its entirety. Briefly, a cutting tool system can be used to cut a tool which can be used to produce films with microstructured surfaces of the disclosure. A cutting tool system employs a thread cut lathe turning process and includes a roll that can rotate around and/or move along a central axis by a driver, and a cutter for cutting the roll material. The cutter is mounted on a servo and can be moved into and/or along the roll along the x-direction by a driver. In general, the cutter can be mounted normal to the roll and central axis and be driven into the engravable material of roll while the roll is rotating around the central axis. The cutter can be then driven parallel to the central axis to produce a thread cut. The cutter can be simultaneously actuated at high frequencies and low displacements to produce features in the roll that when microreplicated result in microstructured surfaces of the disclosure.

The servo can be a fast tool servo (FTS) and can include a solid state piezoelectric (PZT) device, often referred to as a PZT stack, which rapidly adjusts the position of the cutter. Rotary movements produced by the driver are synchronized with translational movements produced by the driver to accurately control the resulting shapes of the microstructures. To prepare the tools for creating the exemplary microstructured film surfaces of FIGS. 7A-8C, the cutter was shaped to have a rounded tip with radius that ranged between 1 and 3 microns and an apex angle beta of 80 degrees (±5 degrees).

The rotation of the roll along the central axis and the movement of the cutter along the x-direction while cutting the roll material defines a thread path around the roll that has a pitch P along the central axis. As the cutter moves along a direction normal to the roll surface to cut the roll material, the width of the material cut by the cutter changes as the cutter moves or plunges in and out. The cutter is angularly adjusted and vertically displaced in such a fashion to create a thread path that may have some element of over-cutting that eliminates portions of the previously created undulating, pseudo-random pattern(s). This process of angular adjustment and vertical displacement is repeated 3-7 times, or however many are needed, to engrave the entire surface of the roll with a pattern. The engraved roll serves as the tool for preparing films with microstructured surfaces that are a negative replication of the microstructured surface of the tool.

Although this cutting method is described with respect to rotation of a roll, randomizing the displacement in the y-direction and/or randomizing the displacement in the x-direction can also be utilized to cut a planar surface. Likewise, overcutting can also be utilized to cut a planar surface. It is also appreciated that some of the thread paths formed by the cutting tool may not incorporate randomized displacement or overcutting. For example, portions of the array of FIGS. 7A-8C may comprise a regular repeating pattern such as a linear array of prisms.

In some embodiments, a single cutter is used for cutting the array of microstructures. In other embodiments, more than one cutter is used for cutting the array of microstructures. For example, taller peaks may be formed with a cutter having a rounded tip and shorter peaks may be formed with a cutter having sharp or less rounded tips. The surface of the tool typically has a surface roughness of less than 50, 40, 30, or 20 nm. Thus, the surface of the microstructures can have this same surface roughness. It is appreciated that the surface roughness of the tool/surface of the microstructures does not include the roughness contributed by the microstructures and thus is not the same as the roughness of the microstructured surface.

Further, although this cutting method is exemplified with respect to modifying the fabrication of an array of linear prisms, these same principles of randomizing the displacement in the y-direction alone and/or randomizing the displacement in the x-direction and/or overcutting can also be utilized to modify the fabrication of other microstructured arrays such as cube corner elements including preferred geometry cube corner elements; both of which are described in WO 2021/033151 (Connell et al.), incorporated herein by reference. In this embodiment, the microstructured surface may be characterized as comprising modified cube corner structures or modified preferred geometry cube corner structures.

FIGS. 7A-7B and 8A-8C are perspective views of illustrative (e.g., micro)structured surfaces comprising an array of peak structures according to the present disclosure. Notably, the cross-sectional view of the peak structures shows that the peak structures have a triangular cross section. In some embodiments, the surfaces of FIGS. 7A-7B and 8A-8C may be characterized as “modified” linear prisms. The peak structures comprise facets, or in other words faces, that form continuous surfaces in the same direction. When the microstructured surface comprises an array of modified cube corner structures the peak structures comprise facets that form semi-continuous surfaces in the same direction, as described in WO 2021/033151. When the microstructured surface comprises an array of modified preferred geometry cube corner structures the peak structures comprise facets that form both continuous and semi-continuous surfaces in the same direction.

When a microstructured surface comprises a regular repeating pattern, various dimensions such as peak height and maximum valley width can be determined by a cross-section orthogonal to the y-axis. Various angles such as the apex angle and side wall angle can also be determined by a cross-section orthogonal to the y-axis. However, when the microstructured surface is not a regular repeating pattern, or in other words is a more complex microstructured surface, multiple cross sections may be utilized to determine these parameters. Further, when the microstructure surface comprises peaks and valleys with different peak heights, different valley depths, different angles, etc. these parameters may more commonly be expressed for example by a minimum, maximum, or average value. The (micro)structures surfaces, as illustrated by FIGS. 7A-7B and 8A-8C can be characterized as having greater variability or in other words greater randomness as compared to the linear prisms of WO 2021/033151 and described above.

In contrast to the linear prisms of WO 2021/033151, the (e.g., modified linear prism) microstructured surface of each of FIGS. 7A-7B and 8A-8C comprises peaks and/or valleys of different heights. Further, the (e.g., modified linear prism) microstructured surfaces of FIGS. 7A-7B and 8A-8C comprise peaks and/or valleys of different widths. The minimum and maximum valley height, valley width, peak height and peak width of the microstructured surfaces of FIGS. 7A-7B and 8A-8B are reported in the following tables. Samples 1-4 correspond to Examples 1-4 of WO 2023/105372 (Jones et al.)

Valley Dimensions

| | Minimum | Maximum | Minimum | Maximum |
|---|---|---|---|---|
| | Valley | Valley | Valley | Valley |
| Sample | Height | Height | Width | Width |
| Sample 1 | 3.75 | 8.16 | 9.08 | 17.33 |
| Sample 2 | 7.40 | 12.40 | 11.50 | 16.50 |
| Sample 3 | 3.65 | 8.27 | 7.45 | 17.40 |
| Sample 4 | 6.86 | 10.73 | 11.56 | 18.15 |

Notably the valley structures vary in height (difference between the minimum and maximum) by at least 1, 2, 3, 4 or 5 microns. In some embodiments, the valley structures vary in height by no greater than 20, 10, 15, or 5 microns. Notably the valley structures vary in width (difference between the minimum and maximum) by at least 1, 2, 3, 4, 5, 6, 7, 8, 9, or 10 microns. In some embodiments, the valley structures vary in height by no greater than 20, 10, 15, or 5 microns.

Peak Dimensions

| | Minimum | Maximum | Average | Minimum | Maximum |
|---|---|---|---|---|---|
| | Peak | Peak | Peak | Peak | Peak |
| Sample | Height | Height | Height | Width | Width |
| Sample 1 | 11.3 | 15.0 | 11.7 | 9.1 | 19 |
| Sample 2 | 10.7 | 11.2 | 9.8 | 9.9 | 18.2 |
| Sample 3 | 10.8 | 15.6 | 10.9 | 10.8 | 16.5 |
| Sample 4 | 15.1 | 19.7 | 13.3 | 10.1 | 17.8 |

Notably the peak structures vary in height (difference between the minimum and maximum) by at least 1, 2, 3, 4 or 5 microns. In some embodiments, the peak structures vary in height by no greater than 20, 10, 15, or 5 microns. Notably the peak structures vary in width (difference between the minimum and maximum) by at least 1, 2, 3, 4, 5, 6, 7, 8, 9, or 10 microns. In some embodiments, the peak structures vary in height by no greater than 20, 10, 15, or 5 microns.

It is appreciated that the amount of variation can be a function of the size. Stated otherwise, the amount of variation is typically at least 10, 15, 20, 25, 30, 35, 40, 45, or 50% of the average dimension (e.g., peak height, peak width, valley height, valley width, etc.) In some embodiments, the amount of variation is less than 45, 40, 35, 30, 25, 20, 15%. Thus, when the microstructured surface has an average dimension of 10 microns, the amount of variation typically ranges from 1 to 5 microns. Likewise, when the microstructured surface has an average dimension of 1 micron, the amount of variation typically ranges from 0.1 to 0.5 microns.

FIG. 8C is a negative replication or in other words inverse of the surface of FIG. 8B. A negative replication can be made, for example, by casting and cure a polymerizable resin onto a metal tool, such as nickel, nickel-plated copper or brass. The tool preferably has a surface energy that allows clean removal of the polymerized material from the tool.

Upon removing the cured polymerizable resin from the metal tool, the resulting film will have a microreplicated surface wherein the peak structures of the tool correspond to valleys, or in other words cavities, in the film and the valleys of the tool correspond to peak structures in the films. It is to be understood that the microstructured film should comprise a material that will not melt or otherwise deform during the thermoforming process of forming the article such that the utilitarian discontinuities of the microstructured surface of the film maintain their shapes and impart the inverse of their shapes to a surface of the final article.

For this embodiment, the peak dimensions of the structured surface of FIG. 8C are the same as the valley dimensions described for Sample 4 of FIG. 8B. Further, the valley dimensions of the structured surface of FIG. 8C are the same as the peak dimensions of Sample 4, depicted by FIG. 8B.

The complex surfaces of the present disclosure were characterized using surface analysis. Topographic data was collected using a VK-200 Keyence Laser Scanning Confocal Microscope (Keyence Corporation, Itasca, IL). A stitched image was generated using the native image assembly software provided with the microscope. An array of 35 individual images (using a 150X Nikon objective) was used to produce a roughly 300×600 micrometer dataset. The dataset was further analyzed using the software package Digital Surf Mountains Map (Digital Surf, Besancon, France) to measure surface roughness parameters and to produce the 3-dimensional surface-plots of FIGS. 7A-7B and 8A-8C.

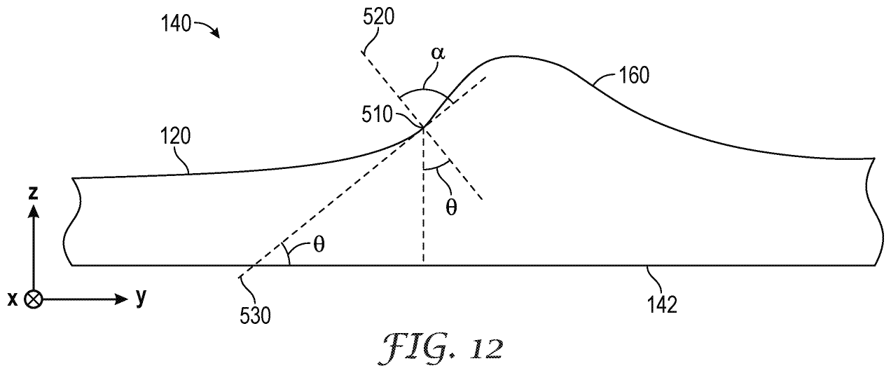

FIG. 12 is a schematic side-view of (micro)structure 160 of (micro)structured surface 120. Structure 160 has a slope distribution across the surface of the structure. For example, the microstructure has a slope θ at a location 510 where θ is the angle between normal line 520 which is perpendicular to the microstructure surface at location 510 (α=90 degrees) and a tangent line 530 which is tangent to the microstructure surface at the same location. Slope θ is also the angle between tangent line 530 and major surface 142 of the matte layer.

The slope of the (micro)structures, slope of the (micro)structured surface 120 was first taken along an x direction, and then along a y direction, such that:

$$X - slope = \frac{\partial H ( x , y )}{\partial x} , and \qquad Equation 1$$

$$Y - slope = \frac{\partial H ( x , y )}{\partial y} \qquad Equation 2$$

where, H(x,y)=the height profile of the surface.

Average x-slope and y-slope were evaluated in a 2 micron interval centered at each pixel. In different embodiments the micron interval may be chosen to be smaller or larger, so long as a constant interval is used with sufficient resolution for the microstructure size. The interval selected is less than the minimum peak width of the structure. In some embodiments, the ratio of the interval to the minimum peak width is at least 3:1, 4:1 or 5:1. Therefore, for smaller structures, smaller intervals would be selected and typically larger intervals for larger structures. Each pixel has a slope and each structure typically has more than one set of x, y coordinates and thus more than one calculated slope value. When a micro-sized interval is selected for evaluating the slope of a microstructured surface, the presence of nanostructures typically does not significantly change the Fcc of the microstructured surface. For example, a 200 nm nanostructure changes the coordinates of a 10 micron microstructure by 2%. From the x-slope and y-slope data, it is possible to determine a gradient magnitude from following Equation 3.

$$GradientMagnitude = \sqrt{{( \frac{\partial H ( x , y )}{\partial x} )}^{2} + {( \frac{\partial H ( x , y )}{\partial y} )}^{2}} \qquad Equation 3$$

Average gradient magnitude was then capable of being evaluated in a 6 μm×6 μm box centered at each pixel. Gradient magnitude was generated within a bin size of 0.5 degrees. Gradient magnitude distribution may be written as N_{G}. It should be understood that in order to find the angle degree value of the x-slope, y-slope and gradient magnitude angles that corresponds to the values above, the arctangent of the values in Equations 1, 2, and 3 should be taken. Another characterization of the surface, is the Complement Cumulative Distribution (F_{CC}(θ)), defined as the fraction (or percentage by multiplying the fraction by 100%) of the gradient magnitudes that are greater than or equal to a particular angle θ. Complement Cumulative Distribution (F_{CC}(θ)), is defined as

$${F}_{CC} ( θ ) = \frac{{\sum }_{q = θ}^{∞} {N}_{G} ( θ )}{{\sum }_{q = 0}^{∞} {N}_{G} ( θ )} \qquad Equation 4$$

Therefore, when it is stated that a certain percentage of the structured surface has a slope magnitude that is less than a certain number of degrees, this characterization is derived from the F_{CC}(θ) in Equation 4. Gradient magnitude corresponds to a combination of the x and y-slopes, and therefore, gradient magnitude may be understood as a general slope magnitude. It should be understood that the terms “gradient magnitude” and “slope magnitude” may be used interchangeably throughout this description and these terms should be understood to have the same meaning. When the total surface is microstructured, such as depicted by FIGS. 7A-7B and 8A-8C and the interval selected is less than the minimum peak width of the microstructures as previously described, the Fcc of the total surface is also the Fcc of the microstructured surface and the Fcc of the microstructures X-slope distributions (Xcc), Y-slope distributions (Ycc) and F(cc) were calculated for embodied microstructured surfaces, as illustrated by FIGS. 7A-7B and 7A-7C.

FIG. 9 is a plot of the complement of the cumulative gradient (i.e., slope) magnitude distribution (Fcc) that was calculated from the topographic data of the surfaces of FIGS. 7A-7B and 8A-8B as compared to comparative examples. Comparative Example A is a representative brightness enhancing film (e.g., Example 1 of WO 2021/033162). Comparative Example B is a representative cube corner film (e.g., Example 20 of WO 2021/033162). Notably, the microstructures of these comparative microstructured surfaces have a narrow distribution of slope. 90% of the microstructures of the surface of Comparative Example A and B have a slope of at least 30 degrees. 80% of the microstructures of the surface of Comparative Example A have a slope of at least 45 degrees (i.e., half the apex angle); whereas 80% of the microstructures of the microstructured surface of Comparative Example B have a slope of at least 40 degrees (i.e., half the apex angle). Less than 5% of the microstructures of both Comparative Example A and B have a slope less than 20 degrees. Further less than 5% of the microstructures have a slope greater than 50 degrees. For regular repeating patterns, such as Comparative Example A and B, the slope calculated from topographic data obtained from surface analysis can be substantially the same as the side wall angle as can be calculated from a cross section.

Notably, the surfaces illustrated by FIGS. 7A-7B and 8A-8C have a much broader distribution of slope. Notably, the structured surface comprises a plurality of structures having a complement cumulative slope magnitude distribution (Fcc) such that at least 30, 40, 50, 60, 70, 80 or 90% of structures have a slope greater than 10 degrees. Further, in some embodiments, less than 80% of the structures have a slope greater than 35 degrees. In some embodiments, the structured surfaces described herein, illustrated by FIGS. 7A-7B and 8A-8C, comprise a plurality of structures having a complement cumulative slope magnitude distribution (Fcc) that meet one or more of the following criteria:
a) at least 10, 20, 30, 40, 50, 60, 70 or 80% of structures have a slope greater than 20 degrees;
b) at least 10, 20, 30, 40, 50, 60, or 70% of structures have a slope greater than 30 degrees;
c) at least 10, 20, 30, 40, or 50% of structures have a slope greater than 40 degrees;
d) at least 10, 20, or 30% of structures have a slope greater than 50 degrees;
e) at least 10 or 20% of structures have a slope greater than 60 degrees;
f) less than 20, 10% of structures have a slope greater than 70 degrees;
g) less than 50, 40, 30, or 20% of structures have a slope greater than 60 degrees;
h) less than 50 or 40% of structures have a slope greater than 50 degrees;
i) less than 70, 60, or 50% of structures have a slope greater than 40 degrees;
j) less than 90 or 80% of structures have a slope greater than 30 degrees; and
k) less than 90% of structures have a slope greater than 20 degrees.

The complement cumulative slope magnitude distribution (Fcc) of FIG. 8C, i.e., the negative replication of FIG. 8B, can also be characterized by the same complement cumulative slope magnitude distribution (Fcc) criteria as just described. The structured surfaces, illustrated by FIGS. 7A-7B and 8A-8C, may be characterized by various combinations of the complement cumulative slope magnitude distribution (Fcc) criteria just described and in some embodiments all the criteria just described.

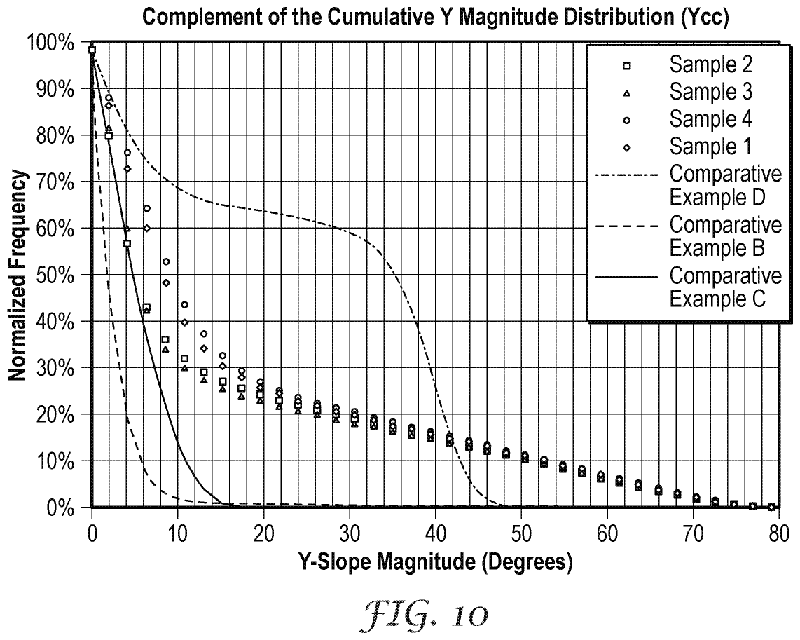

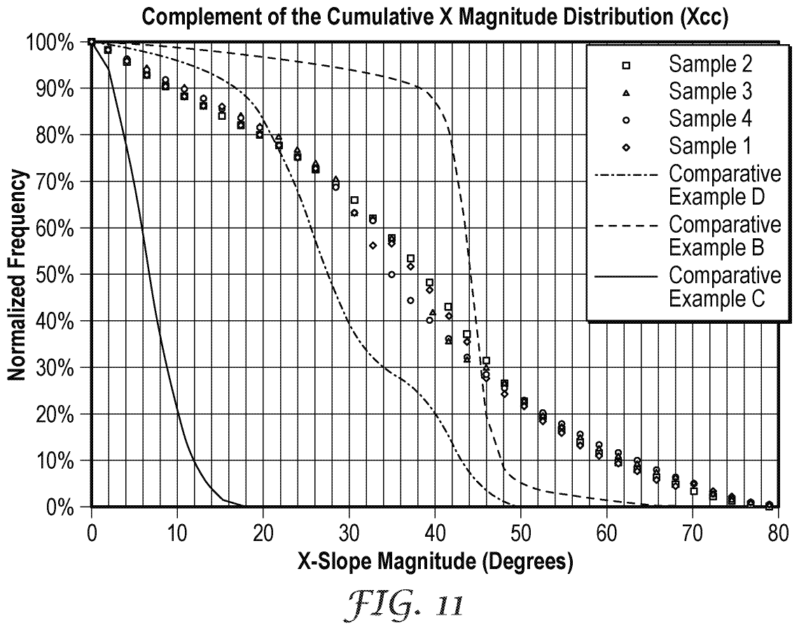

FIG. 10 is a plot of the complement of the cumulative gradient (i.e., slope) magnitude distribution (Ycc) of structured surfaces, illustrated by FIGS. 7A-7B and 8A-8B. These surfaces comprise a plurality of structures having a complement cumulative slope magnitude distribution (Ycc) wherein at least 20, 25, 30, 35, 40, 45, or 50% of the structures have a slope greater than 10 degrees and less than 55, 50, 45, 40, 35, 30, 25, or 20% of the structures have a slope greater than 30 degrees. In some embodiments, the structured surfaces described herein, illustrated by FIGS. 7A-7B and 8A-8B, comprise a plurality of structures having a complement cumulative slope magnitude distribution (Ycc) that meet one or more of the following criteria:
a) at least 10 or 20% of structures have a slope greater than 20 degrees;
b) at least 10 or 20% of structures have a slope greater than 30 degrees;
c) at least 10 or 15% of structures have a slope greater than 40 degrees;
d) at least 10% of structures have a slope greater than 50 degrees;
e) at least 5% of structures have a slope greater than 60 degrees;
f) less than 10 or 5% of structures have a slope greater than 70 degrees;
g) less than 20 to 10% of structures have a slope greater than 60 degrees;
h) less than 50, 40, 30, 20 or 10% of structures have a slope greater than 50 degrees;
i) less than 90, 80, 70, 60, 50, 40, 30 or 20% of structures have a slope greater than 40 degrees;
j) less than 90, 80, 70, 60, 50, 40, or 30% of structures have a slope greater than 20 degrees; and
k) less than 90, 80, 70, 60, 50, 40, or 30% of structures have a slope greater than 10 degrees.

FIG. 11 is a plot of the complement of the cumulative gradient (i.e., slope) magnitude distribution (Xcc) of structured surfaces, illustrated by FIGS. 7A-7B and 8A-8B. These surfaces comprise a plurality of structures having a complement cumulative slope magnitude distribution (Xcc) wherein at least 45, 50, or 60% of the structures have a slope greater than 30 or 35 degrees; and less than 85 or 80% of the structures have a slope greater than 40 degrees. In some embodiments, the structured surfaces described herein, illustrated by FIGS. 7A-7B and 8A-8B, comprise a plurality of structures having a complement cumulative slope magnitude distribution (Xcc) that meet one or more of the following criteria:
a) at least 10, 20, 30, 40, 50, 60, 70, or 80% of structures have a slope greater than 10 degrees;
b) at least 10, 20, 30, 40, 50, 60, or 70% of structures have a slope greater than 20 degrees;
c) at least 10, 20, 30, 40, 50, or 603 of structures have a slope greater than 40 degrees; d) at least 10 or 20% of structures have a slope greater than 50 degrees;
e) at least 109 of structures have a slope greater than 60 degrees;
f) less than 20 or 10% of structures have a slope greater than 70 degrees;
g) less than 50, 40, 30 or 20% of structures have a slope greater than 60 degrees;
h) less than 50, 40, or 30% of structures have a slope greater than 50 degrees;
i) less than 90, 80, or 70% of structures have a slope greater than 30 degrees; and
j) less than 90 or 80% of structures have a slope greater than 20 degrees.

It is appreciated that the structured surface of FIG. 8C can also be characterized by the same complement cumulative slope magnitude distribution (Xcc) and (Ycc) criteria as just described.

Various other surface roughness parameters, Sa (Roughness Average), Sq (Root Mean Square), Sku (Surface Kurtosis), and Sbi (Surface Bearing Index), Svi (Valley Fluid Retention Index) were calculated from the topographic images (3D)). Prior to calculating roughness, a plane correction was used “Subtract Plane” (1^{st} order plane fit form removal).

The following table describes S parameters of some representative examples and comparative examples. Notably some of the comparative examples are also described in WO 2021/033151.

| | Sa | Sq | | | |
|---|---|---|---|---|---|
| Sample/Example | [nm] | [nm] | Sbi | Svi | Sbi/Svi |
| Sample 1 | 2613 | 3215 | 0.75 | 0.110 | 7 |
| Sample 2 | 2445 | 2975 | 0.56 | 0.095 | 6 |
| Sample 3 | 2893 | 3577 | 0.33 | 0.096 | 3 |
| Sample 4 | 3549 | 4352 | 0.67 | 0.096 | 7 |
| Example 19 of | 1899 | 2215 | 0.53 | 0.086 | 6 |
| WO2021/033162 | | | | | |
| BEF epoxy | | | | | |
| Example 20 of | 10496 | 12504 | 0.97 | 0.039 | 25 |
| WO2021/033162 | | | | | |
| Cube Corner epoxy | | | | | |
| Example 1 of | 1961 | 2263 | 1.95 | 0.072 | 27 |
| WO2021/033162 | | | | | |
| BEF polymerized resin | | | | | |
| Example 6 of | 27327 | 32252 | 3.92 | 0.063 | 62 |
| WO2021/033162 | | | | | |
| Example 7 of | 5846 | 6620 | 2.80 | 0.064 | 44 |
| WO2021/033162 | | | | | |
| Example 8 of | 27289 | 32142 | 3.13 | 0.107 | 29 |
| WO2021/033162 | | | | | |
| Comp. B of | 366 | 457 | 0.28 | 0.092 | 3 |
| WO2021/033162 | | | | | |
| Smooth epoxy | | | | | |
| Comp. A of | 30 | 63 | 0.10 | 0.120 | 1 |
| WO2021/033162 | | | | | |
| Smooth | | | | | |
| Polymerized Resin | | | | | |
| Comp. E of | 41627 | 42389 | 7.1 | 0.017 | 417 |
| WO2021/033162 | | | | | |
| Square Wave | | | | | |
| Comp. F of | 21002 | 21428 | 1.22 | 0.013 | 95 |
| WO2021/033162 | | | | | |
| Square Wave | | | | | |

Topography maps can be obtained using confocal laser scanning microscopy (CLSM), e.g., a Keyence VK-X200. CLSM is an optical microscopy technique that scans the surface using a focused laser beam to map the topography of a surface. CLSM works by passing a laser bean through a light source aperture which is then focused by an objective lens into a small area on the surface and image is built up pixel-by-pixel by collecting the emitted photons from the sample. It uses a pinhole to block out-of-focus light in image formation. Dimensional analysis can be used to measure various parameters using SPIP 6.7.7 image metrology software according to the manual (see https://www.imagemetcom/nedia-libra/spondocrenes).

Surface roughness parameters, Sa (Roughness Average), Sq (Root Mean Square), and Sbi (Surface Bearing Index), Svi (Valley Fluid Retention Index) can be calculated from the topographic images (3D). Prior to calculating roughness, a plane correction is used “Subtract Plane” (1^{st} order planefit form removal).

### The Roughness Average, Saₜ is Defined as:

$${S}_{a} = \frac{1}{MN} {\sum }_{k = 0}^{M - 1} {\sum }_{l = 0}^{N - 1} \vert z ( {x}_{k} , {y}_{l} ) \vert$$

where M and N are the number of data points X and Y.

Although smooth surfaces can have a Sa approaching zero, the comparative smooth surfaces that were found to have poor microorganism removal after cleaning had an average surface roughness, Sa, of at least 10, 15, 20, 25 or 30 nm. The average surface roughness, Sa, of the comparative smooth surfaces was less than 1000 nm (1 micron). In some embodiments, Sa of the comparative smooth surface was at least 50, 75, 100, 125, 150, 200, 250, 300, or 350 nm. In some embodiments, Sa of the comparative smooth surface was no greater than 900, 800, 700, 600, 500, or 400 nm.

The average surface roughness, Sa, of the microstructured surfaces having improved microorganism removal after cleaning was 1 micron (1000 nm) or greater. In some embodiments, Sa was at least 1100 nm, 1200 nm, 1300 nm, 1400 nm, 1500 nm, 1600 nm, 1700 nm, 1800 nm, 1900 nm, or 2000 nm (2 microns). In some embodiments, Sa of the microstructured surfaces was at least 2500 nm, 3000 nm, 3500 nm, 4000 nm or 5000 nm. In some embodiments, Sa of the microstructured surfaces was at least 10,000 nm, 15,000 nm, 20,000 nm or 25,000 nm. In some embodiments, Sa of the microstructured surfaces having improved microorganism removal after cleaning was no greater than 40,000 nm (40 microns), 35,000 nm, 30,000 nm, 15,000 nm, 10,000 nm, or 5,000 nm.

In some embodiments, Sa of the microstructured surface is at least 2 or 3 times the Sa of a smooth surface. In other embodiments, Sa of the microstructured surface is at least 4, 5, 6, 7, 8, 9, or 10 times the Sa of a smooth surface. In other embodiments, Sa of the microstructured surface is at least 15, 20, 25, 30, 35, 40, 45, 50 times the Sa of a smooth surface. In other embodiments, Sa of the microstructured surface is at least 100, 200, 300, 400, 500, 600, 700, 800, 900, or 1000 times the Sa of a smooth surface.

### The Root Mean Square (RMS) Parameter Sq, is Defined as:

$${S}_{q} = \sqrt{\frac{1}{MN} {\sum }_{k = 0}^{M - 1} {\sum }_{l = 0}^{N - 1} {[ z ( {x}_{k} , {y}_{l} ) ]}^{2}}$$

where M and N are the number of data points X and Y.

Although the Sq values are slightly higher than the Sa values, the Sq values also fall within the same ranges just described for the Sa values.

### The Surface Kurtosis, Sku, Describes the “Peakedness” of the Surface Topography, and is Defined as:

$${S}_{ku} = \frac{1}{MN {S}_{q}^{4}} {\sum }_{k = 0}^{M - 1} {\sum }_{l = 0}^{N - 1} {[ z ( {x}_{k} , {y}_{l} ) ]}^{4} \qquad R4$$

| Sample/Example | Sku |
|---|---|
| Sample 2 | 2.424 |
| Sample 3 | 2.796 |
| Sample 4 | 2.565 |
| Sample 1 | 2.490 |
| Comparative Example D | 2.390 |
| Comparative Example B | 1.924 |
| Comparative Example A | 1.786 |

Notably Samples 1-4 have a Sku greater than Comparative Examples A, B, and D. In some embodiments, the Sku is greater than 2.40, 2.45, 2.50, 2.55, 2.60, 2.65, 2.70, or 2.75. In some embodiments, the Sku is less than 3.00, 2.95, 2.90, 2.85, 2.80, 2.75, 2.70, 2.65, 2.60 or 2.55, or 2.50, or 2.45.

### The Surface Bearing Index, Sbi, is Defined as:

$${S}_{bi} = \frac{{S}_{q}}{{Z}_{0.05}} ,$$

wherein Z_{0.05} is the surface height at 5% bearing area.

### The Valley Fluid Retention Index, Svi, is Defined as:

$${S}_{vi} = \frac{{V}_{v} ( {h}_{0.8} )}{( M - 1 ) ( N - 1 ) δ x δ y} / {S}_{q} ,$$

wherein Vv(h0.80) is the void volume at valley zone within 80-100% bearing area.

As noted in the S Parameters table above, the Sbi/Svi ratio of the comparative smooth samples were 1 and 3. The microstructured surfaces having improved microorganism removal after cleaning had a Sbi/Svi ratio of greater than 3. The microstructured surfaces have a Sbi/Svi ratio of at least 4, 5, or 6. In some embodiments, the microstructured surfaces having improved microorganism removal after cleaning had a Sbi/Svi ratio of at least 7, 8, 9, or 10. In some embodiments, the microstructured surfaces having improved microorganism removal after cleaning had a Sbi/Svi ratio of at least 15, 20, 25, 30, 35, 40 or 45. The microstructured surfaces having improved microorganism removal after cleaning had a Sbi/Svi ratio of less than the comparative square wave microstructured surfaces. Thus, the microstructured surfaces having improved microorganism removal after cleaning had a Sbi/Svi ratio of less than 90, 85, 80, 75, 70 or 65. In some embodiments, the microstructured surfaces having improved microorganism removal after cleaning had a Sbi/Svi ratio of less than 60, 55, 50, 45, 40, 35, 30, 25, 20, or 10.

Topography maps can also be used to measure other features of the microstructured surface. For example, the peak height (especially of a repeating peak of the same height) can be determined from the height histogram function of the software. To calculate the percentage of “flat regions” of a square wave film, the “flat regions” can be identified using SPIP's Particle Pore Analysis feature, which identifies certain shapes (in this case, the “flat tops” of the microstructured square wave film).

In certain embodiments, the microstructured surface comprises peak structures and adjacent valleys having a complement cumulative slope magnitude distribution (Fcc) such that at least 30, 40, 50, 60, 70, 80 or 90% of structures have a slope greater than 10 degrees; and less than 80% of the structures have a slope greater than 35 degrees.

In select cases, the microstructured surface comprises less than 30% of flat surface area that is parallel to a planar base layer.

In alternate embodiments, the substrate layer is planar, such that it exhibits an average surface roughness, Sa, of less than 1000 nm. A planar substrate layer lacks a microstructured surface as described in detail above.

### Optional Additives & Coatings

Optionally, a low surface energy coating may be applied to the substrate layer. Exemplary low surface energy coating materials that may be used include materials such as hexafluoropropylene oxide (HFPO), or organosilanes such as, alkylsilane, alkoxysilane, acrylsilanes, polyhedral oligomeric silsequioxane (POSS) and fluorine-containing organosilanes, just to name a few. Examples of particular coatings known in the art may be found, e.g., in US Publication No. 2008/0090010 (Zhang et al.), and commonly owned publication, US Publication No. 2007/0298216 (Jing et al.). A coating may be applied by any appropriate coating method, such as sputtering, vapor deposition, spin coating, dip coating, roll-to-roll coating, or any other number of suitable methods.

In some embodiments, the substrate layer may be modified to make a major surface opposite the metal oxide layer more hydrophilic. A microstructured surface generally may be modified such that a flat organic polymer film surface of the same material as the modified microstructured surface exhibits an advancing or receding contact angle of 45 degrees or less with deionized water. In the absence of such modifications, a flat organic polymer film surface of the same material as the microstructured surface typically exhibits an advancing or receding contact angle of greater than 45, 50, 55, or 60 degrees with deionized water.

Any suitable known method may be utilized to achieve a hydrophilic substrate layer surface. Surface treatments may be employed such as plasma treatment, vacuum deposition, polymerization of hydrophilic monomers, grafting hydrophilic moieties onto the film surface, corona or flame treatment, etc. For certain embodiments, the hydrophilic surface treatment comprises a zwitterionic silane, and for certain embodiments, the hydrophilic surface treatment comprises a non-zwitterionic silane. Non-zwitterionic silanes include a non-zwitterionic anionic silane, for instance.

In other embodiments, the hydrophilic surface treatment further comprises at least one silicate, for example and without limitation, comprising lithium silicate, sodium silicate, potassium silicate, silica, tetraethylorthosilicate, poly(diethoxysiloxane), or a combination thereof. One or more silicates may be mixed into a solution containing the hydrophilic silane compounds, for application to the (e.g., microstructured) surface.

### Articles

Since one useful object is to provide an article having a surface with increased microorganism (e.g., bacteria) removal when cleaned, the article is typically not a (e.g., sterile) medical article such as nasal gastric tubes, wound contact layers, blood stream catheters, stents, pacemaker shells, heart valves, orthopedic implants such as hips, knees, shoulders, etc., periodontal implants, dentures, dental crowns, contact lenses, intraocular lenses, soft tissue implants (breast implants, penile implants, facial and hand implants, etc.), surgical tools, sutures including degradable sutures, cochlear implants, tympanoplasty tubes, shunts including shunts for hydrocephalus, post-surgical drain tubes and drain devices, urinary catheters, endotracheal tubes, heart valves, wound dressings, other implantable devices, and other indwelling devices. The medical articles just described may be characterized as single use articles, i.e., the article is used once and then discarded. The above articles may also be characterized as single person (e.g., patient) articles. Thus, such articles are typically not cleaned (rather than sterilized) and reused with other patients.

In contrast, the articles and surfaces described herein include those where the microstructured surface is exposed to the surrounding (e.g., indoor or outdoor) environment and is subject to being touched or otherwise coming in contact with multiple people and/or animals, as well as other contaminants (e.g., dirt).

In some embodiments, the microstructured surface of the article, comes in direct (e.g., skin) contact with (e.g., multiple) people and/or animals during normal use of the article. In other embodiments, the microstructured surface may come is close proximity to (e.g., multiple) people/or animals in the absence of direct (e.g., skin) contact. However, since the microstructured surface comes in close proximity such article surfaces can easily be contaminated with microorganisms (e.g., bacteria) and are therefore cleaned to prevent the spreading of microorganisms to others.

Representative articles that would be cleaned during normal use and/or are amenable for use integrating the microstructured surface into a curved surface of the article include various interior or exterior surfaces or components of a medical article, a dental article, an orthodontic article, a vehicular article, an electronic article, a personal care article, a cleaning article, an athletic article, a food preparation article, a child care article, or an architectural article. More particularly, some examples of representative articles of these categories may include the following:
a) vehicular articles (e.g., automobile, bus, train, airplane, boat, ambulances, ships), such as head rests, dashboards, door panels, window shutter (e.g., of an airplane), gear shifter, seat belt buckle, instrument and button panels, arm rests, railings, luggage compartments, steering wheels, handlebars, etc.);
b) medical articles or dental articles including (e.g., non-sterile) surfaces of a medical, dental, or laboratory facility or medical, dental, or laboratory equipment (e.g., defibulators, ventilators and CPAPs (especially masks thereof), face shields, crutches, wheelchairs, bed rails, breast pump devices, IV pole and bags, dental tools (e.g., hand tools used during dental cleaning and restoration procedures), curing lights (e.g., for dental materials), exam tables, etc.;
c) orthodontic articles including aligners (e.g., clear tray aligners), retainers, night guards, splints, class II and class III correctors, sleep apnea devices, bite openers, bands, brackets, buccal tubes, cleats, buttons, other attachment devices, etc.;
d) electronic articles including housings and cases of electronic devices (e.g., phones, laptops, tablets, or computers) as well as keyboards, mouses, projectors, printers, remote control devices, locks, chargers (including cords & docking stations), fobs, video and arcade games, slot machines, automatic teller machines; and point of sale electronic devices such as credit card readers, keypads, stylists, cash registers, barcode scanner, payment kiosks, etc.;
e) personal care articles including toothbrushes, eye glass frames, shoes, clothing, handbags, etc.;
f) cleaning articles including vacuums, mops, scrub brushes, dusters, toilet bowl cleaners, plungers, brooms, etc.;
g) athletic articles including helmets, guards, balls and hand-held equipment for various sports including baseball, lacrosse, tennis, football, basketball, soccer, and golf, etc.;
h) food preparation articles appliances (e.g., microwaves, stoves, ovens, blenders, toasters, coffee makers, refrigerators), grills, utensils (e.g., especially handles thereof), condiment bottles, salt & pepper shakers, galleys, carts, cutting boards, lunch boxes, thermoses, tables and chairs (especially for public dining in restaurants, dorms, nursing homes, and prisons), etc.;
i) child care articles including toys, pacifiers, bottles, teethers, car seats, cribs, changing tables, playground equipment, etc.; and
j) architectural articles including railings, countertops, desktops, cabinets, lockers, window sills, electrical modulators (e.g. light switches, dimmers, and outlets), components of furniture (e.g., desks, tables, chairs, seats and armrests); handles (e.g. knob, pull, levers including locks) of articles including furniture, doors of buildings, turn styles, appliances, vehicles, shopping carts and baskets, surfaces and components of lavatories (e.g. sink, toilet surfaces (e.g. levers), drain caps, shower walls, bathtub, vanity, countertop), etc.

The microstructured surface is particularly advantageous for congregate living facilities such as military housing, prisons, dorms, nursing homes, apartments, hotels; public places such as offices, schools, arenas, casinos, bowling alleys, golf courses, arcades, gyms, salons, spas, shopping centers, airports, train stations; and public transportation.

The term “microorganism” is generally used to refer to any prokaryotic or eukaryotic microscopic organism, including without limitation, one or more of bacteria (e.g., motile or nonmotile, vegetative or dormant, Gram positive or Gram negative, planktonic or living in a biofilm), bacterial spores or endospores, algae, fungi (e.g., yeast, filamentous fungi, fungal spores), mycoplasmas, and protozoa, as well as combinations thereof. In some cases, the microorganisms of particular interest are those that are pathogenic, and the term “pathogen” is used to refer to any pathogenic microorganism.

Examples of pathogens can include, but are not limited to, both Gram positive and Gram negative bacteria, fungi, and viruses including members of the family Enterobacteriaceae, or members of the family Micrococaceae, or the genera Staphylococcus spp., Streptococcus, spp., Pseudomonas spp., Acinetobacter spp., Enterococcus spp., Salmonella spp., Legionella spp., Shigella spp., Yersinia spp., Enterobacter spp., Escherichia spp., Bacillus spp., Listeria spp., Campylobacter spp., Acinetobacter spp., Vibrio spp., Clostridium spp., Klebsiella spp., Proteus spp. Aspergillus spp., Candida spp., and Corynebacterium spp. Particular examples of pathogens can include, but are not limited to, Escherichia coli including enterohemorrhagic E. coli e.g., serotype O157:H7, O129:H111; Pseudomonas aeruginosa; Bacillus cereus; Bacillus anthracis; Salmonella enteritidis; Salmonella enterica serotype Typhimurium; Listeria monocytogenes; Clostridium botulinum; Clostridium perfringens; Staphylococcus aureus; methicillin-resistant Staphylococcus aureus; carbapenem-resistant Enterobacteriaceae, Campylobacter jejuni; Yersinia enterocolitica; Vibrio vulnificus; Clostridium difficile; vancomycin-resistant Enterococcus; Klebsiella pnuemoniae; Proteus mirabilus and Enterobacter [Cronobacter]sakazakii.

### EXEMPLARY EMBODIMENTS

In a first embodiment, the present disclosure provides a multilayered article. The multilayered article comprises a substrate layer comprising a fluoropolymer or a silicone polymer; a metal oxide layer directly attached to a major surface of the substrate layer, the metal oxide layer having a thickness of 15 nanometers (nm) to 60 nm; and an adhesive layer adjacent to a major surface of the metal oxide layer opposite the substrate layer. The article exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

In a second embodiment, the present disclosure provides a multilayered article according to the first embodiment, further comprising at least one intermediate layer disposed between the metal oxide layer and the adhesive layer.

In a third embodiment, the present disclosure provides a multilayered article according to the first embodiment or the second embodiment, wherein the adhesive layer is directly attached to the metal oxide layer.

In a fourth embodiment, the present disclosure provides a multilayered article according to any of the first through third embodiments, wherein the metal oxide layer comprises at least one of titanium oxide, aluminum oxide, zinc oxide, tantalum pentoxide, zirconium oxide, or niobium oxide.

In a fifth embodiment, the present disclosure provides a multilayered article according to any of the first through fourth embodiments, wherein the metal oxide layer comprises titanium oxide.

In a sixth embodiment, the present disclosure provides a multilayered article according to any of the first through fifth embodiments, wherein the metal oxide layer has a thickness of 15 nm to 20 nm, 20 nm to 30 nm, or 20 nm to 40 nm.

In a seventh embodiment, the present disclosure provides a multilayered article according to any of the first through sixth embodiments, exhibiting an average transmission of at least one of 0°, 30°, 45°, 60°, or 75° incident light angle of light having a wavelength range of at least above 410 nm of 70% or greater.

In an eighth embodiment, the present disclosure provides a multilayered article according to any of the first through seventh embodiments, exhibiting an average transmission of at least one of 0°, 30°, 45°, 60°, or 75° incident light angle of light over a wavelength bandwidth of at least 30 nanometers having a wavelength between 200 nm to 280 nm, 200 nm to 300 nm, or 200 nm to 320 nm, of 10% or less, 7%, 5%, or 2% or less.

In a ninth embodiment, the present disclosure provides a multilayered article according to any of the first through eighth embodiments, wherein the metal oxide layer is not a part of a multilayer optical film.

In a tenth embodiment, the present disclosure provides a multilayered article according to any of the first through ninth embodiments, wherein the adhesive layer comprises a pressure-sensitive adhesive or a hot melt adhesive.

In an eleventh embodiment, the present disclosure provides a multilayered article according to any of the first through tenth embodiments, wherein the adhesive layer comprises a pressure-sensitive adhesive.

In a twelfth embodiment, the present disclosure provides a multilayered article according to any of the first through eleventh embodiments, wherein the adhesive layer comprises a polyisobutylene adhesive, a silicone adhesive, or a (meth)acrylic adhesive.

In a thirteenth embodiment, the present disclosure provides a multilayered article according to any of the first through twelfth embodiments, exhibiting a peel force between the metal oxide layer and the adhesive layer of 500 grams per inch (196.9 grams per centimeter) or greater.

In a fourteenth embodiment, the present disclosure provides a multilayered article according to any of the first through thirteenth embodiments, exhibiting a peel force between the substrate layer and the metal oxide layer of 500 grams per inch (196.9 grams per centimeter) or greater.

In a fifteenth embodiment, the present disclosure provides a multilayered article according to any of the first through fourteenth embodiments, wherein the substrate layer comprises a fluoropolymer.

In a sixteenth embodiment, the present disclosure provides a multilayered article according to any of the first through fifteenth embodiments, wherein the substrate layer comprises a fluoropolymer (co)polymer comprising polymerized units derived from one or more monomers selected from tetrafluoroethylene, hexafluoropropylene, vinylidene fluoride, a perfluoroalkoxy alkylene, or a combination thereof.

In a seventeenth embodiment, the present disclosure provides a multilayered article according to any of the first through sixteenth embodiments, wherein the substrate layer comprises a silicone thermoplastic polymer.

In an eighteenth embodiment, the present disclosure provides a multilayered article according to any of the first through seventeenth embodiments, wherein the substrate layer is a single layer having a thickness of 10 microns to 500 microns.

In a nineteenth embodiment, the present disclosure provides a multilayered article according to any of the first through eighteenth embodiments, wherein the substrate layer is a microstructured substrate comprising: a base layer having a thickness of at least 1 micron; and a plurality of microstructures extending across a first surface of the base layer.

In a twentieth embodiment, the present disclosure provides a multilayered article according to any of the first through nineteenth embodiments, wherein the microstructured surface comprises peak structures and adjacent valleys, wherein the valleys have a maximum width ranging from 1 micron to 250 microns and the peak structures have a side wall angle of greater than 10 degrees.

In a twenty-first embodiment, the present disclosure provides a multilayered article according to any of the first through nineteenth embodiments, wherein the microstructured surface comprises peak structures and adjacent valleys having a complement cumulative slope magnitude distribution (Fcc) such that at least 30, 40, 50, 60, 70, 80 or 90% of structures have a slope greater than 10 degrees; and less than 80% of the structures have a slope greater than 35 degrees.

In a twenty-second embodiment, the present disclosure provides a multilayered article according to any of the first through nineteenth embodiments, wherein the microstructured surface comprises less than 30% of flat surface area that is parallel to a planar base layer.

In a twenty-third embodiment, the present disclosure provides a multilayered article according to any of the first through twenty-second embodiments, exhibiting a change in light transmission at a wavelength of 400 nm of less than 10% following exposure to UVC light having a wavelength of 254 nm at a dosage of 50 megajoules per square meter (MJ/m²).

In a twenty-fourth embodiment, the present disclosure provides a multilayered article according to any of the nineteenth through twenty-third embodiments, wherein the microstructured surface can provide a log 10 reduction of microorganism of at least 2, 3, 4, 5, 6, 7 or 8 after cleaning.

### EXAMPLES

The following Examples are merely for illustrative purposes and are not meant to be overly limiting on the scope of the appended claims.

Unless otherwise noted or otherwise apparent from the context, all parts, percentages, ratios, and the like in the Examples and the rest of the specification are provided on the basis of weight.

### Materials Used in the Examples

| Abbreviation | Description and Source |
|---|---|
| THV815GZ | Fluoropolymer, obtained under the trade designation “3M Dyneon ™ |
| | Fluoroplastic Granules THV 815GZ”, from 3M Company, St. Paul, |
| | MN |
| FSA1250 | A UVA loaded acrylic pressure sensitive transfer adhesive, obtained |
| | from 3M Company, St. Paul, MN |
| 91022 | Silicone acrylic pressure sensitive transfer adhesive, obtained from |
| | 3M Company, St. Paul, MN, under trade designation “3M Adhesive |
| | Transfer Tape 91022” |
| 81504 | Polyisobutylene pressure sensitive transfer adhesive, obtained from |
| | 3M Company, St. Paul, MN, under trade designation “3M Adhesive |
| | Transfer Tape 81504” |
| TiO₂ | TiO₂ source material was obtained from Kurt J Lesker Company; |
| | Jefferson Hills, PA., under trade name “Titanium Oxide tablets, |
| | TiO₂, 99.9% pure” |

### Interlayer Adhesion Strength Test:

The samples prepared according to the Examples and Comparative Examples described below were tested for their interlayer adhesion strength. For each Example or Comparative Example sample two 1″×10″ (2.54 cm×25.4 cm) strips were prepared. Then the two strips were further laminated to each other in an adhesive against adhesive configuration. The interlayer adhesion strength of the resulting sample was determined using an IMASS Tape Peel Tester (Model SP-2000, obtained from IMASS, Inc., Accord, MA) according to the ASTM-D1876-08(2015)e1 “Standard Test Method for Peel Resistance of Adhesives (T-Peel Test)” available from ASTM International, West Conshohocken, PA.

### Test for Loss in Light Transmission:

The samples prepared according to the Examples and Comparative Examples described below were tested for their light transmission at 400 nm using a Shimadzu Spectrometer (obtained under the trade designation “SHIMADZU 2550 UV-VIS” from Shimadzu, Kyoto, Japan), before and after exposing them to 100 megajoules per square meter (MJ/m²) UVC radiation at a wavelength of 254 nm emitted from a germicidal lamp (118V RRD-30-8S germicidal fixture manufactured by Atlantic Ultraviolet Corporation, Hauppauge, NY). Percent loss of transmission after exposure to UVC radiation was calculated. Loss in light transmission at 400 nm indicates photo-oxidative degradation has occurred.

### Preparatory Example 1 (PE1): Preparation of THV815GZ Fluoropolymer Substrate with a Microstructured Surface

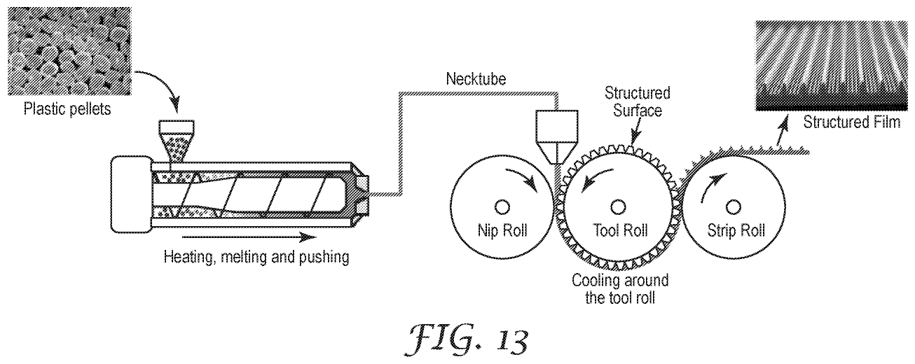

The THV815GZ fluoropolymer substrate of PE1 having a microstructured surface was prepared using the process schematically illustrated in FIG. 13 using a three-roll vertical stack molding apparatus which included an extruder and extrusion die adapted for extruding one or more layers of molten thermoplastic material into a mold. The mold was a microstructured film, obtained under trade designation “3M™ Brightness Enhancement Film BEF4-DT-90 (24)”, obtained from 3M Company, St. Paul, MN, wound onto a cylindrical casting roll to provide a desired surface pattern for transference to the molten THV815GZ fluoropolymer from an extruder as it passed over the cylindrical surface of the roll. The mold surface had linear prism microstructures. The casting roll had a surface temperature of 76.6° C. and a casting roll speed of 18.8 meters/minute. A nip force of 7600 pounds (33806 N) was applied to the THV815GZ fluoropolymer as it contacted the mold on the casting roll. The resulting THV815GZ fluoropolymer substrate of PE1 was 2-mil (50-micrometers) thick and had a surface comprising a microstructure in the form of linear prisms. The detailed features of the microstructured surface of PE1 substrate as determined by confocal laser scanning microscopy (CLSM), are summarized in the below table of Microstructure Features.

### Microstructure Features

| | | | Side | |
|---|---|---|---|---|
| Peak | Peak | Included | Wall | Tip |
| Height | Pitch | Angle | Angle | Radius |
| (micrometers) | (micrometers) | (degrees) | (degrees) | (micrometers) |
| 6-12 | 24 | 90 | 45 | 2-10 |

### Preparative Example 2 (PE2): Vapor Coating of UV-Barrier Layer (TiO₂) on Bottom Surface of PE1 Substrate

The bottom surface (opposite the microstructured surface) of PE1 substrate was coated with a UV-barrier coating comprising TiO₂ using a Denton Vacuum Optical Coater (obtained from Denton Vacuum, Moorestown, NJ) consisting of a 5-planet planetary drive system located ˜30″ (76.2 cm) above a 4-pocket Temescal Electron Beam gun (obtained from Ferro Tec Corporation, Livermore, CA). The planetary system was designed to hold the substrate perpendicular to the evaporation source and to move in a planetary-type motion in and out of the evaporation plume during the deposition.

The actual process for the coating was as follows: a) the vapor coater was vented to atmosphere and one of the five planets was removed. The substrate to be coated was adhered to the planet by a polyimide tape. The sample was oriented so that the bottom surface of PE1 was exposed for coating. b) The planet was reinstalled, and the other 4 planets were configured similarly, if needed, and they too were reinstalled in the coater. c) The chamber was closed and pumped to a vacuum level of <2×10⁻⁵ Torr (2.7×10⁻³ Pa). This is usually about 10 sccm for added oxygen gas. d) The planetary was started and moved around the coater at a rotational speed of ˜60 rpm to prepare for coating and to achieve a high level of uniformity on the attached substrates. e) A Temescal electron beam gun power supply was energized. A voltage of 10 kV and a current of a few milliamps was applied to the e-gun's filament, heating the TiO₂ source material in the e-gun. The TiO₂ source was heated and controlled via an Eddy Company Optical Monitoring System (OMS) (from Eddy Company, Apple Valley, CA). The source was heated until the desired deposition rate of 4 angstroms per second was achieved and steady, a shutter separating the source from the planets was opened and the rate was maintained via the OMS until the desired thickness was achieved, at which point the shutter closed and the OMS shut power off to the e-beam source. f) The main power to the power supply was turned off and the source allowed to cool for about 10 minutes. h) The chamber was then vented back to atmospheric pressure via N₂ gas, and each planet was removed and the resulting coated PE2 substrate was removed from the coater.

The thickness of the TiO₂ UV-barrier layer formed above was about 40 nm.

### Comparative Examples 1-3 (CE1-CE3)

CE1 sample was prepared by hand laminating the PE1 fluoropolymer substrate with FSA 1250 acrylic pressure sensitive transfer adhesive. The adhesive was laminated on the surface of PE1 fluoropolymer opposite the microstructured surface.

CE2 and CE3 samples were prepared in the same manner as CE1, except that the adhesive used was 91022 silicone acrylic pressure sensitive transfer adhesive for CE2, and 81504 polyisobutylene pressure sensitive transfer adhesive for CE3.

CE1-CE3 samples were then tested for their interlayer adhesion strength (of adhesive to PE1 fluoropolymer substrate) and for loss in light transmission using the tests described above. The results of the tests are summarized in the table of Test Results, below.

### Examples 4-6 (E4-E6)

E4-E6 samples were prepared in the same manner as CE1 above, except that PE2 fluoropolymer substate was used and the selected adhesive was laminated on the UV-barrier (TiO₂) coated side of the PE2 fluoropolymer substrate.

The adhesive was FSA1250 acrylic pressure sensitive transfer adhesive for E4, 91022 silicone acrylic pressure sensitive transfer adhesive for E5, and 81504 polyisobutylene pressure sensitive transfer adhesive for E63.

E4-E6 samples were then tested for their interlayer adhesion strength (of adhesive to UV-barrier coated side of PE2 fluoropolymer substrate) and for loss in light transmission using the tests described above. The results of the tests are summarized in the table of Test Results, below.

### Test Results

| | Sample | | | | | |
|---|---|---|---|---|---|---|
| Test | CE1 | CE2 | CE3 | E4 | E5 | E6 |
| Interlayer Adhesion | 5.9 | 9.8 | 5.9 | >196.9 | >196.9 | >196.9 |
| (grams/cm) | | | | | | |
| Loss in Light | 25 | 15 | 30 | 0 | 0 | 5 |
| Transmission | | | | | | |
| at 400 nm (%) | | | | | | |

1. A multilayered article comprising:
a substrate layer comprising a fluoropolymer or a silicone polymer;
a metal oxide layer directly attached to a major surface of the substrate layer, the metal oxide layer having a thickness of 15 nanometers (nm) to 60 nm; and
an adhesive layer adjacent to a major surface of the metal oxide layer opposite the substrate layer,
wherein the article exhibits an average transmission of at least one of 0°, 30°, 45°, 60°, or 75° incident light angle of light over a wavelength bandwidth of at least 30 nanometers having a wavelength between at least 200 nm and 400 nm of 10% or less, 7%, 5%, or 2% or less.

2. (canceled)

3. The multilayered article of claim 1, wherein the adhesive layer is directly attached to the metal oxide layer.

4. The multilayered article of claim 1, wherein the metal oxide layer comprises at least one of titanium oxide, aluminum oxide, zinc oxide, tantalum pentoxide, zirconium oxide, or niobium oxide.

5. (canceled)

6. The multilayered article of claim 1, wherein the metal oxide layer has a thickness of 15 nm to 20 nm, 20 nm to 30 nm, 20 nm to 40 nm, 30 nm to 60 nm, 40 nm to 60 nm, or 50 nm to 60 nm.

7. The multilayered article of claim 1, exhibiting an average transmission of at least one of 0°, 30°, 45°, 60°, or 75° incident light angle of light having a wavelength range of at least above 410 nm of 70% or greater.

8. The multilayered article of claim 1, exhibiting an average transmission of at least one of 0°, 30°, 45°, 60°, or 75° incident light angle of light over a wavelength bandwidth of at least 30 nanometers having a wavelength between 200 nm to 280 nm, 200 nm to 300 nm, or 200 nm to 320 nm, of 10% or less, 7%, 5%, or 2% or less.

9. The multilayered article of claim 1, wherein the metal oxide layer is not a part of a multilayer optical film.

10. The multilayered article of claim 1, wherein the adhesive layer comprises a pressure-sensitive adhesive or a hot melt adhesive.

11. The multilayered article of claim 1, wherein the adhesive layer comprises a pressure-sensitive adhesive.

12. The multilayered article of claim 1, wherein the adhesive layer comprises a polyisobutylene adhesive, a silicone adhesive, or a (meth)acrylic adhesive.

13. The multilayered article of claim 1, exhibiting a peel force between the metal oxide layer and the adhesive layer of 500 grams per inch (196.9 grams per centimeter) or greater.

14. The multilayered article of claim 1, exhibiting a peel force between the substrate layer and the metal oxide layer of 500 grams per inch (196.9 grams per centimeter) or greater.

15. The multilayered article of claim 1, wherein the substrate layer comprises a fluoropolymer.

16. The multilayered article of claim 1, wherein the substrate layer comprises a fluoropolymer (co)polymer comprising polymerized units derived from one or more monomers selected from tetrafluoroethylene, hexafluoropropylene, vinylidene fluoride, a perfluoroalkoxy alkylene, or a combination thereof.

17. The multilayered article of claim 1, wherein the substrate layer comprises a silicone thermoplastic polymer.

18. The multilayered article of claim 1, wherein the substrate layer is a single layer having a thickness of 10 microns to 500 microns.

19. The multilayered article of claim 1, wherein the substrate layer is a microstructured substrate comprising: a base layer having a thickness of at least 1 micron; and a plurality of microstructures extending across a first surface of the base layer.

20. The multilayered article of claim 19, wherein the microstructured surface comprises peak structures and adjacent valleys, wherein the valleys have a maximum width ranging from 1 micron to 250 microns and the peak structures have a side wall angle of greater than 10 degrees.

21. (canceled)

22. The multilayered article of claim 19, wherein the microstructured surface comprises less than 30% of flat surface area that is parallel to a planar base layer.

23. The multilayered article of claim 1, exhibiting a change in light transmission at a wavelength of 400 nm of less than 10% following exposure to UVC light having a wavelength of 254 nm at a dosage of 50 megajoules per square meter (MJ/m²).

24. (canceled)
